(19) United States
(12) Patent Application Publication
(10) Pub. No.: US 2026/0289375 A1
(43) Pub. Date: Sep. 24, 2026

(54) LAYERED SEQUENCE TABLE ARCHITECTURE FOR LARGE-SCALE QUANTUM COMPUTERS

(71) Applicant: International Business Machines Corporation, Armonk, NY (US)

(72) Inventors: Thomas Alexander, Halifax (CA); Thilo Maurer, Nufringen (DE); Scott M. Willenborg, Stewartville, MN (US); Patrick Julian Tassilo Rall, Boston, MA (US); Diego Ristè, Watertown, MA (US)

(21) Appl. No.: 19/084,118

(22) Filed: Mar. 19, 2025

(51) Int. Cl. G06N 10/60; G06N 10/40

(52) U.S. Cl. CPC G06N 10/60; G06N 10/40

(57) ABSTRACT

A system comprises a logical control unit (LCU) operably couplable to a quantum computer system and operating an instruction interface for logical control over an operation of a quantum program at the quantum computer system. The LCU comprises a programmable processor, a memory, operably coupled to the programable processor and comprising dedicated memory regions comprising an instruction element storage, and a circuit execution unit (CEU) that interprets the quantum program and generates, using an instruction element of the instruction element storage, a logical instruction that comprises a discrete higher-level instruction for the operation of the quantum program at the quantum computer system. The CEU interfaces with a code control unit (CCU) for provision of the logical instruction for use by the CCU in generating a physical instruction that comprises a lower-level instruction for execution of a specified quantum hardware of the quantum computer system.

### BACKGROUND

The subject disclosure relates to quantum program control for large-scale, fault-tolerant quantum computer systems, and more particularly to quantum program control that deconstructs high-level, quantum program language into low-level instructions operable to execute quantum hardware at the quantum computer systems.

### SUMMARY

The following presents a summary to provide a basic understanding of one or more embodiments described herein. This summary is not intended to identify key or critical elements, and/or to delineate scope of particular embodiments and/or scope of claims. Its sole purpose is to present concepts in a simplified form as a prelude to the more detailed description that is presented later. In one or more embodiments, systems, computer-implemented methods, apparatuses, and/or computer program products described herein can provide for quantum program control comprising use of primitive, classical processing to generate higher-level, discrete, logical instructions driving real-time adaptation of lower-lever, higher-frequency generation of physical instructions for executing quantum hardware of a quantum computer system to thereby operate the quantum program.

To provide these features, the innovation employs a classically-operated network of one or more logical control units (LCUs) that each employ dedicated memory storage regions and comprise or control one or more specified circuit execution units (CEUs). Each CEU can interpret the quantum program and generate logical instructions that generally define how to operate the quantum program absent specification to event timing, such as based on a physical clock, special processing unit (SPU) timing, and/or timing of physical stimulus to quantum hardware. Each CEU can be assigned to one or more specified code control units (CCUs) that, using the logical instructions generated by the CEU, generate lower-level physical instructions to be performed, such as defining specific quantum hardware-executing instructions, according to event timing, such as a physical clock, SPU timing, and/or timing of physical stimulus to quantum hardware. In this way, run-time adaptation of operation of the quantum program can be classically controlled, during operation of the quantum program at the quantum computer system, using discrete, reduced bandwidth, event timing-agnostic, and reduced-frequency generation of logical instructions that generally define an outline or roadmap for operation of the quantum program. This is as compared to continuous (or near-continuous), higher-bandwidth, event timing-driven, and higher frequency generation of physical instructions that generally directly implement physical operations (e.g., wave generation, pulse generation, signal operation, etc.) for executing specified aspects of quantum hardware at the quantum computer system, thereby ultimately effecting the operation of the quantum program.

In accordance with an embodiment, a system can comprise a logical control unit operably couplable to a quantum computer system and operating an instruction interface with the quantum computer system for logical control over an operation of a quantum program at the quantum computer system, the logical control unit comprising a programmable processor, a memory, operably coupled to the programable processor and comprising dedicated memory regions comprising an instruction element storage, and a circuit execution unit that interprets the quantum program and generates, using an instruction element of the instruction element storage, a logical instruction that comprises a discrete higher-level instruction for the operation of the quantum program at the quantum computer system, wherein the circuit execution unit interfaces with a code control unit for provision of the logical instruction for use by the code control unit in generating a physical instruction that comprises a lower-level instruction for execution of a specified quantum hardware of the quantum computer system.

In one or more embodiments thereof, the circuit execution unit executes classical control flow driving adaptation of quantum operations for the quantum program by generating the logical instruction during the operation of the quantum program at the quantum computer system.

In one or more embodiments thereof, operations performed by the logical control unit and the circuit execution unit, comprising the interpreting and interfacing, are agnostic to event timing by which the code control unit operates.

In one or more embodiments thereof, the instruction interface operated by the logical control unit comprises a lower-complexity interface requiring lower bandwidth for operating per code control unit, comprising the code control unit, than is employed by the code control unit.

In accordance with another embodiment, a computer-implemented method can comprise operating, by a logical control unit operably couplable to a quantum computer system, an instruction interface with the quantum computer system for logical control over an operation of a quantum program at the quantum computer system, storing, by the logical control unit, an instruction element at an instruction element storage of dedicated memory regions of a memory of the logical control unit, the memory operably coupled to a programmable processor of the logical control unit, interpreting, by a circuit execution unit of the logical control unit, the quantum program, generating, by the circuit execution unit, using the instruction element, a logical instruction that comprises a discrete higher-level instruction for the operation of the quantum program at the quantum computer system, and interfacing, by the circuit execution unit, with a code control unit for provision of the logical instruction for use by the code control unit in generating a physical instruction that comprises a lower-level instruction for execution of a specified quantum hardware of the quantum computer system.

In one or more embodiments thereof, operations performed by the logical control unit and the circuit execution unit, comprising the interpreting and interfacing, are agnostic to event timing by which the code control unit operates.

In one or more embodiments thereof, the instruction interface operated by the logical control unit comprises a lower-complexity interface requiring lower bandwidth for operating per code control unit, comprising the code control unit, than is employed by the code control unit.

In one or more embodiments thereof, the method further comprises generating, by the lower-complexity interface, comprising the circuit execution unit, logical instructions, comprising the logical instruction, at a first average instruction rate that is less than a second average instruction rate at which the code control unit generates physical instructions, comprising the physical instruction.

In accordance with still another embodiment, a computer program product can facilitate adaptation of an operation of a quantum program at a quantum computer system, the computer program product comprising a computer readable storage medium having program instructions embodied therewith, the program instructions executable by a processor of a logical control unit operably couplable to the quantum computer system to cause the processor to operate, by the processor, an instruction interface with the quantum computer system for logical control over the operation of the quantum program at the quantum computer system, store, by the processor, an instruction element at an instruction element storage of dedicated memory regions of a memory of the logical control unit, the memory operably coupled to the processor, interpret, by the processor, the quantum program, generate, by the processor, using the instruction element, a logical instruction that comprises a discrete higher-level instruction for the operation of the quantum program at the quantum computer system, and interface, by the processor, with a code control unit for provision of the logical instruction for use by the code control unit in generating a physical instruction that comprises a lower-level instruction for execution of a specified quantum hardware of the quantum computer system.

In one or more embodiments thereof, operations performed by the logical control unit, comprising the interpreting and interfacing, are agnostic to event timing by which the code control unit operates.

In one or more embodiments thereof, the instruction interface operated by the logical control unit comprises a lower-complexity interface requiring lower bandwidth for operating per code control unit, comprising the code control unit, than is employed by the code control unit.

In one or more embodiments thereof, the program instructions can be further executable by the processor to cause the processor to generate, by the processor, logical instructions, comprising the logical instruction, at a first average instruction rate that is less than a second average instruction rate at which the code control unit generates physical instructions, comprising the physical instruction.

A benefit of the system, computer-implemented method, and/or computer program product can be use of a primitive instruction interface, providing hierarchical communication. As used herein, the term “primitive instruction interface” can refer to a high-level instruction interface, such as where a user entity can provide a quantum code for a specific backend without having to explicitly manage some of the finer details, such as specific quantum hardware operations, physical clock correspondence, etc. Put another way, a primitive instruction interface can allow a high-level user entity to provide quantum algorithms without specifically considering one or more of these finer details. Thus, the primitive instruction interface of the logical control unit (LCU), including the circuit execution unit (CEU), can control a higher abstraction level without specifying particular quantum gates, signal intensities, phase or wave parameters, physical clock correspondence, etc. The hierarchical communication can allow for further reduction in processing by allowing multiple interconnected (e.g., networked) logical control units to together form primitive instruction management for operation of a quantum program or for operation of a portion of a quantum program.

Another benefit of the system, computer-implemented method, and/or computer program product can be soft, real-time circuit execution unit (CEU) operation, driving run-time adaptation of a quantum program. As used herein, the terms “real-time” and “run-time” can refer to provision during operation of a quantum program. That is, generation of a logical instruction by a CEU can allow for the LCU to provide dynamic (e.g., updatable, changeable, and/or adaptable) classical control flow of quantum operations during operation of a quantum program at a quantum computer system. As such, lower bandwidth, less complex, and/or off-quantum system classical computing can drive quantum operation at a quantum computer system while allowing for implementing adaptation of future quantum instructions (e.g., relative to a same quantum program operation).

For example, in one or more embodiments described herein, this manner of operation can comprise run-time adaptation based on quantum measurement results. For example, the LCU can generally obtain a classical observable result defining a quantum measurement readout of the quantum computer system, from the quantum computer system or from a code control unit (CCU). Then, the associated CEU can execute classical control flow driving adaptation of quantum operations for the quantum program by generating the logical instruction based on the classical observable result during the operation of the quantum program at the quantum computer system.

In this way, fewer constraints are inherently associated with the one or more systems described herein, such as with respect to what types of quantum programs can be executed by the one or more systems. That is, use of the one or more systems described herein desirably avoid direct programming of physical qubit executions which have a high instruction rate. Instead, classical computing, which operates one or more orders of magnitude more slowly, can be employed to, at a high level, provide a road map or outline via lower-frequency/lower-rate logical instruction generation to thereby control the higher-frequency/higher rate generation of physical instructions. As a result, a quantum program can be operated without direct programming of all or any physical qubit instructions, which can allow for more efficient, easier, faster, and/or less complex quantum program operation facilitation. This can also allow less-experienced user entities to operate a complex quantum program without directly facilitating the associated, complex quantum program operation. Furthermore, this type of operation provided by the one or more embodiments described herein can make it easier to build or engineer a specific hierarchically-distributed, multi-LCU quantum operation control network because no one component operates at every level of abstraction or quantum hardware-adjacency.

Still another benefit of the system, computer-implemented method, and/or computer program product can be that an LCU, and the one or more CEUs comprised by and controlled by the LCU, are physical clock agnostic relative to the generation of the logical instructions. That is, the logical level of instructions, comprising the logical instructions, does not correspond to qubits changing state but rather to a series of operations defining how to instruction execution of the physical qubits. Thus, while the instruction of execution of physical qubits by a CCU can be operated according to a physical clock and thus employ greater complexity and bandwidth for physical instruction generation, the LCU can generally be programmed to be ignorant of physical clocks. The LCU can be programed to instruct order of operations and use of dependencies (e.g., shared variables, local variables, observable results, etc.) but does not have to reason regarding time. This can simplify a distribution network for the physical clock as omitting the LCUs and/or CEUs. Put another way, while an LCU does not have to be a real-time system, by relaxing operating requirements for the LCU, the LCU can perform classical operations that subsequently cause real-time operation of the quantum program.

Yet another benefit of the system, computer-implemented method, and/or computer program product can be dedicated memory regions, including a shared variable region that is shared among networked LCUs of a distributed LCU network comprising multiple LCUs. During an operation of a quantum program, the processes running on/at an LCU can call fixed subroutines, observable results local variables, or shared variables, without being limited thereto, that are separately stored at separate dedicated storage regions of a memory of the LCU. The observable results, such as bit values, can be obtained from the quantum computer system or from one or more CCUs for storage at the LCUs. These different stored aspects can be directly written to assigned memory addresses at an LCU. In this way, a CEU and/or CCU can access the dedicated memory regions to change behavior, such as based on a trigger, specified check, change in data/metadata tag, notification, etc. Regarding the CCUs, this can allow for ease of reference by the CCUs without use of significant local memory readout for the CCUs, as a large amount of processing can occur at the CCUs without such CCUs performing work on their dedicated, shared memory. Regarding the CEUs, this can allow such aspects to be operated as processes, components, engines, etc. with the same or similar benefits including separate readout memory access.

Another benefit of the system, computer-implemented method, and/or computer program product can be the use of a distributed CEUs/LCUs network comprising multiple LCUs, with each LCU comprising and/or controlling one or more dedicated CEUs (e.g., CEUs assigned to a respective LCU). Multi-CCU coordination can be provided per CEU, with each CEU controlling one or more dedicated CCUs (e.g., CCUs assigned to a respective CEU). CCUs can each control one or more special processing units (SPUs) that directly execute operations at physical qubits. In one or more cases, SPUs can be stored at a cryogenic environment, although one or more can be stored external to a cryogenic environment. Multiple CCUs can control a same SPU, and multiple SPUs can control a same quantum hardware aspect (e.g., pulse generator). Likewise, a single quantum hardware aspect can send signals to one or more SPUs. As noted above, this type of hierarchically-distributed, multi-LCU quantum operation control network can provide easier operation, engineering, and/or manufacture thereof because no one component operates at every level of abstraction or quantum hardware-adjacency.

### DESCRIPTION OF THE DRAWINGS

FIG. 1 illustrates a block diagram of an example, non-limiting system that can facilitate run-time adaptation of an operation of a quantum program at a quantum computer system, in accordance with one or more embodiments described herein.

FIG. 2 illustrates a schematic flow diagram of one or more processes that can be performed by the non-limiting system of FIG. 1, to provide the run-time adaptation of the operation of a quantum program at the quantum computer system, in accordance with one or more embodiments described herein.

FIG. 3 illustrates a block diagram of a quantum system that can be employed in connection with the non-limiting systems of FIGS. 1 and/or 4, in accordance with one or more embodiments described herein.

FIG. 4 illustrates a block diagram of another example, non-limiting system that can facilitate run-time adaptation of an operation of a quantum program at a quantum computer system, in accordance with one or more embodiments described herein.

FIG. 5 provides a schematic diagram of the non-limiting system of FIG. 4 in the form of an exemplary multi-level control system, in accordance with one or more embodiments described herein.

FIG. 6 provides a schematic diagram of an exemplary logical control unit of the non-limiting system of FIG. 4, in accordance with one or more embodiments described herein.

FIG. 7 provides a schematic diagram of an exemplary logical control unit and one or more code control units of the non-limiting system of FIG. 4, in accordance with one or more embodiments described herein.

FIG. 8 provides a schematic diagram of the one or more code control units, one or more special purpose units, and one or more quantum hardware aspects, in accordance with one or more embodiments described herein.

FIG. 9 provides a schematic diagram of an exemplary distributed LCU network comprising multiple LCUs, in accordance with one or more embodiments described herein.

FIG. 10 provides a set of six schematic diagrams illustrating example quantum circuits that can be operated using primitive instructions that can be generated, by the non-limiting system of FIG. 4, in accordance with one or more embodiments described herein.

FIG. 11 provides a schematic flow diagram of one or more processes that can be performed by the non-limiting system of FIG. 4, to provide the run-time adaptation of the operation of the quantum program at the quantum computer system, in accordance with one or more embodiments described herein.

FIG. 12 illustrates a continuation of the flow diagram of FIG. 11 of one or more processes that can be performed by the non-limiting system of FIG. 4, in accordance with one or more embodiments described herein.

FIG. 13 illustrates a block diagram of an example, non-limiting, computer environment in accordance with one or more embodiments described herein.

### DETAILED DESCRIPTION

The following detailed description is merely illustrative and is not intended to limit embodiments and/or application and/or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Turning first to existing frameworks, existing quantum-control stacks commonly rely on centralized controllers or static compile-time compilation of quantum circuits. Such approaches become inflexible and unscalable as quantum systems grow and require adaptive behavior, such as dynamic routing, measurement-conditioned branching, non-deterministic magic-state distillation, and/or coordinated multi-module operations.

Put another way, as large-scale, fault-tolerant quantum computer systems grow in size, complexity, and/or quantity of quantum hardware employed, such as number of physical qubits employed, user entities will desire to provide quantum programs using a high-level language that is to be deconstructed into low-level instructions with minimum user entity input. The high-level language can consist of both logical quantum circuits as well as classical programs, including classical control, that are to be interpreted and sent to a lower-level code control unit. However, existing frameworks generally directly program what occurs with physical qubits, and the direct programming is currently performed using classical instruction that provides too slow of a rate of instruction for keeping up with a desired speed of physical qubit instructions (e.g., quantum hardware-adjacent instructions) of near-term or future, large-scale quantum computers.

To make up for one or more of these deficiencies, the one or more embodiments disclosed herein can generally provide a logical circuit control architecture designed to enable efficient and scalable execution of logical quantum circuits on large-scale, fault-tolerant quantum computers. At the heart of the architecture is a logical control unit (LCU) that hosts one or more circuit execution units (CEUs). Each CEU executes a classical program that includes complex classical control flow and simultaneously generates logical-level quantum instructions. These logical-level quantum instructions are delivered to and/or otherwise obtained by one or more code control units (CCUs), which in turn generate physical-level quantum instructions and manage the physical-layer details of stabilizer management, syndrome cycles, hardware-specific gate decompositions, and scheduling of quantum hardware executions. This division of responsibilities provides a clean and technically-motivated separation between logical-layer control and physical-layer execution, enabling adaptive, measurement-driven quantum protocols that are generally classically-driven, which cannot be realized through static compilation alone.

That is, one or more embodiments described herein can overcome one or more shortcomings of existing frameworks through a hierarchically-controlled, distributed and networked architecture that incorporates run-time classical interpretation of control flow, real-time generation of logical circuits, a hardware-aligned, primitive-instruction interface that reduces bandwidth requirements to CCUs, and a multi-LCU framework that supports both high-performance local coordination and broader global communication across large devices. Together, these elements can yield a substantial technical improvement by reducing the instruction-rate burden on the control system, enabling dynamic adaptation based on real-time measurement outcomes, and supporting scalable operation across large fault-tolerant quantum processors.

Collectively, these structural and functional innovations provide a number of concrete technical improvements. The architecture described herein leverages scalable, logical-level, classical control over distributed, fault-tolerant quantum computers; substantially reduces bandwidth and timing pressures through the primitive-instruction interface; improves reliability through classical control-flow execution on deterministic CPU hardware; supports adaptive and non-deterministic operations through run-time branching; and/or simplifies verification, debugging, and/or control-stack design by cleanly separating logical and physical circuit layers. The logical-level classically-operated interface, explicit memory organization, control-unit structure, and inter-unit communication patterns directly correspond to the architectural challenges presented by large-scale quantum hardware and provide non-abstract, technically-grounded solutions.

The logical-level classically-operated interface, explicit memory organization, control-unit structure, and inter-unit communication patterns will each be described below in detail relative to the figures as defined above and in connection with the various definitions provided herein, both above and below.

As used herein, the term “compile-time” can refer to a time period of indeterminate length before run-time during which a circuit can be prepared for execution, such as by a classical computer system and/or program.

As used herein, the term “data” can comprise metadata.

As used herein, the term “discrete” can refer to separated, spaced-apart, or having a defined number of states, as compared to “analog” that can refer to a continuous, near-continuous, or having an infinite number of or plurality of states.

As used herein, the term “dynamic” can refer to a property that is determined during a run-time. For example, a dynamic operation can be determined during operation of a quantum program at a quantum computer system.

As used herein, the terms “entity,” “requesting entity,” “user entity,” and “administrating entity” can refer to a machine, device, component, hardware, software, smart device, party, organization, individual and/or human.

As used herein, the term “high-level” can refer to upper hierarchy or affecting upper hierarchy less adjacent to quantum hardware, while the term “low-level” can refer to lower hierarchy or affecting lower hierarchy more adjacent to quantum hardware.

As used herein, the term “lower-complexity interface” can refer to an interface requiring reduced complexity of operation as compared to existing frameworks. For example, while existing frameworks generally directly implement physical operations (e.g., wave generation, pulse generation, signal operation, etc.) for executing specified aspects of quantum hardware at the quantum computer system, a lower-complexity interface as described herein can instead generally function to define how a quantum program is to be operated (e.g., an outline or roadmap for operation) without defining specific quantum hardware for execution.

As used herein, the term “logical circuit” can refer to a high-level quantum circuit specification of an intended action of a quantum circuit.

As used herein, the term “logical instruction” can refer to a high-level instruction that is discrete and/or primitive, and which generally defines how to operate a quantum program without providing exact execution instructions. Accordingly, a logical instruction can be provided absent specifying physical quantum gates, quantum hardware, and/or quantum hardware execution parameters, for example. Further, a logical instruction is not associated with a physical clock or incremented integer of a physical clock.

As used herein, the term “physical circuit” can refer to a low-level quantum circuit specification comprising one or more physical gate operations that are to be executed at a quantum computer system, such as to implement a logical circuit.

As used herein, the term “physical clock” can refer to an integer number that is incremented at regular intervals, and by which quantum hardware executions can be scheduled.

As used herein, the term “physical instruction” can refer to an analog or non-primitive instruction including finer details for quantum hardware execution or quantum hardware-adjacent execution, such as specifying physical quantum gates, quantum hardware, and/or quantum hardware execution parameters, for example. Further, a physical instruction is generally associated with and/or is to be implemented according to a physical clock or incremented integer of a physical clock.

As used herein, the term “primitive instruction interface” can refer to a high-level instruction interfaces, such as where a user can write a quantum code for a specific backend without having to explicitly manage some of the finer details.

As used herein, the terms “real-time” and “run-time” can refer to provision during operation of a quantum program.

As used herein, the term “reduced bandwidth” can refer to a lower level of bandwidth as compared to existing frameworks, for example due to functioning separate from a physical clock, functioning without directly specifying and/or scheduling quantum hardware aspects, and/or functioning at a lower rate of logical instruction generation (e.g., as compared to a higher rate of physical instruction generation).

As used herein, the term “soft” can refer to the ability of a computer program or instruction to be easily modified or changed by user entities as per user entity-specified requirements.

As used herein, the term “soft real-time” can refer to the ability of a computer program or instruction to be easily modified or changed by user entities as per user entity-specified requirements during operation of a quantum program, for example.

As used herein, the term “qubit” can refer to two-dimension qubits, multi-dimension qubits, d-dimensional qudits, and/or superconducting, trapped-ion, neutral-atom, spin, photonic, and/or other qubit modalities, without being limited thereto.

These definitions, and at least those additional definitions provided in the above and below paragraphs of this Description section, clarify the scope of the invention and provide sufficient algorithmic and structural guidance to one skilled in the art, mitigating risks of indefiniteness or lack of enablement.

Next, one or more embodiments are described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices, and/or components depicted therein, nor to any particular order, connection, and/or coupling of systems, devices, and/or components depicted therein.

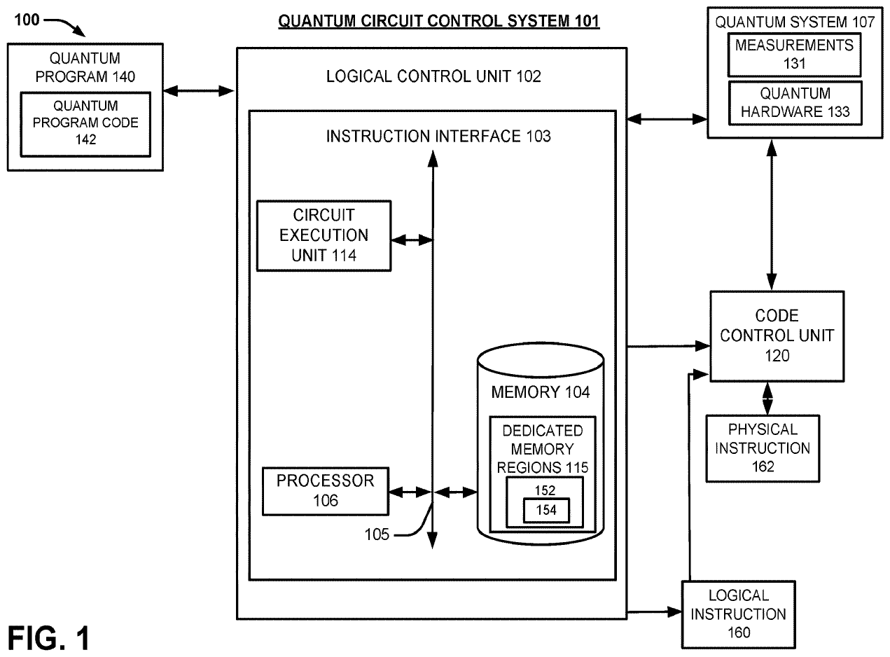

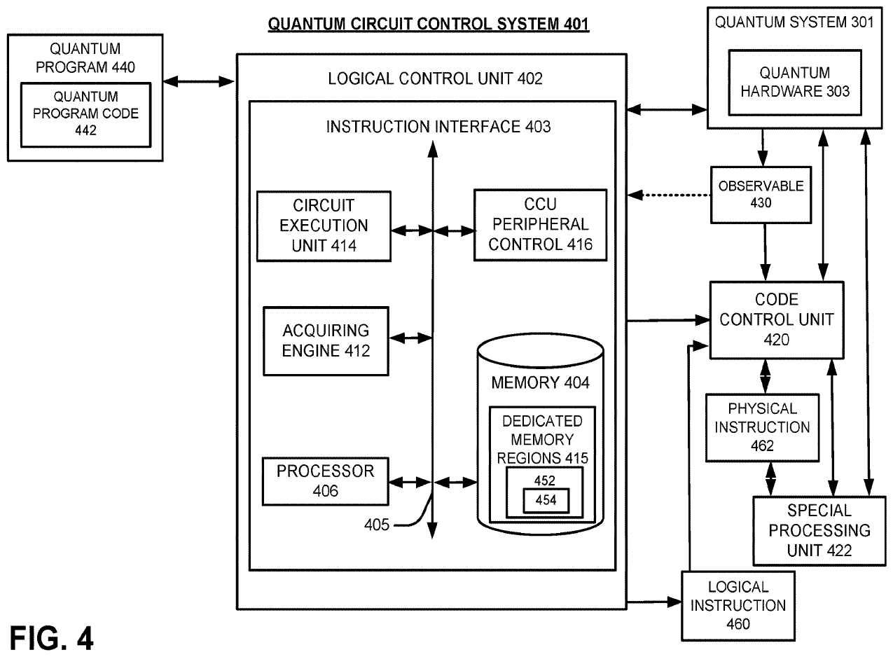

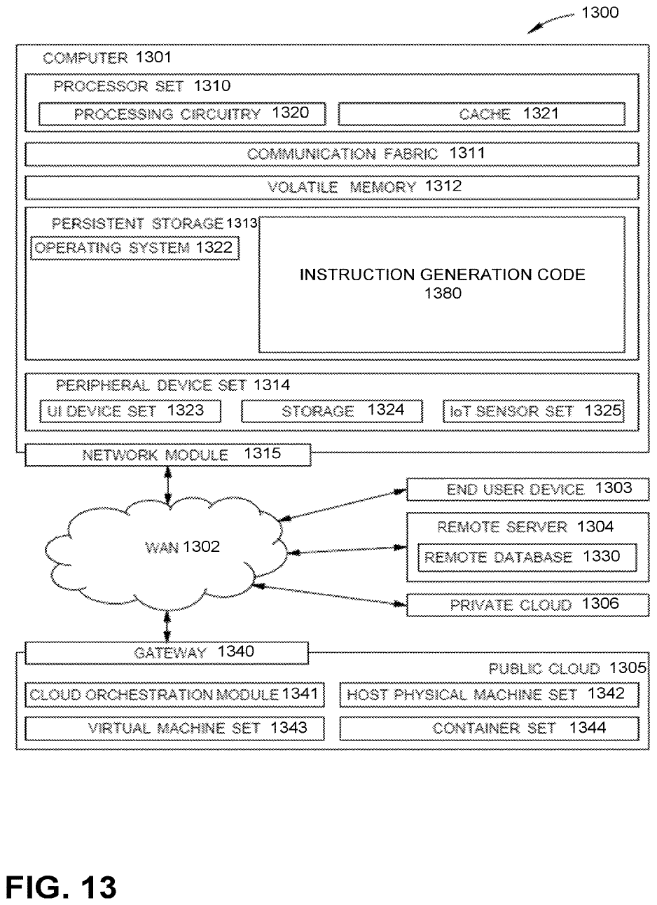

For example, in one or more embodiments, the non-limiting systems 100 and/or 400 illustrated at FIGS. 1 and 4, and/or systems thereof, can further comprise one or more computer and/or computing-based elements described herein with reference to a computing environment, such as the computing environment 1300 illustrated at FIG. 13. In one or more described embodiments, computer and/or computing-based elements can be used in connection with implementing one or more of the systems, devices, components and/or computer-implemented operations shown and/or described in connection with FIGS. 1 and/or 4 and/or with one or more other figures described herein.

Turning now in particular to one or more figures, and first to FIG. 1, the figure illustrates a block diagram of an example, non-limiting system 100 that can provide a process facilitating adaptation of an operation of a quantum program at a quantum computer system, to thereby provide execution of the quantum program at the quantum computer system 107. Quantum processing resulting in measurement readout data is performed by the quantum computer system 107, and classical analysis is performed by the quantum circuit control system 101.

That is, the non-limiting system 100 can comprise a quantum circuit control system 101 and the quantum computer system 107, to be described in detail below. It is noted that the quantum circuit control system 101 is only briefly described relative to FIG. 1 to provide but a lead-in to description of a more complex and/or more expansive quantum circuit control system 401 as illustrated at FIG. 4. Further detail regarding processes that can be performed by one or more embodiments described herein will be provided below relative to the non-limiting system 400 of FIG. 4.

In general, the quantum circuit control system 101 addresses an existingly unaddressed aspect of how to manage high generation rate or frequency of physical quantum instructions in a top down basis. Generally, the quantum circuit control system 101 provides a logical circuit control architecture designed to enable efficient and scalable execution of logical quantum circuits on large-scale, fault-tolerant quantum computers. At the heart of the architecture is a logical control unit (LCU) that hosts one or more circuit execution units (CEUs). Each CEU executes a classical program that includes complex classical control flow and simultaneously generates logical-level quantum instructions. These logical-level quantum instructions are delivered to and/or otherwise obtained by one or more code control units (CCUs), which in turn generate physical-level quantum instructions and handle the physical-layer details of stabilizer management, syndrome cycles, hardware-specific gate decompositions, and scheduling of quantum hardware executions. This division of responsibilities provides a clean and technically-motivated separation between logical-layer control and physical-layer execution, enabling adaptive, measurement-driven quantum protocols that are generally classically-driven, which cannot be realized through static compilation alone.

Still referring to FIG. 1, the quantum circuit control system 101 can comprise at least a memory 104, bus 105, processor 106, and circuit execution 114. Using these components and optionally using one or more outputs from the quantum computer system 107 (e.g., measurements 131), the quantum circuit control system 101 can provide a primitive instruction interface 103 that can drive classical control-based adaptation of a quantum program 140 at run-time. As used herein, the term “primitive instruction interface” can refer to a high-level instruction interfaces, such as where a user can write a quantum code for a specific backend without having to explicitly manage some of the finer details. As used herein, the terms “real-time” and “run-time” can refer to provision during operation of a quantum program.

For example, the logical control unit 102 can be operably couplable to a quantum computer system 107 and operate the instruction interface 103 with the quantum computer system 107 for logical control over an operation of a quantum program 140 at the quantum computer system 107. The logical control unit 102 can comprise a programmable processor 106 and a memory 104. The processor 106 can be programmable using any suitable interface communicatively couplable to the logical control unit 102. Programming can define a level of abstraction at which to provide logical instructions 160, what instruction elements 154 to employ, etc., without being limited thereto.

The memory 104 can be operably coupled to the programmable processor 106 and can comprise a plurality of dedicated memory regions 115 comprising at least an instruction element storage 152. One or more instruction elements 154 can be stored at the instruction element storage 152. As used herein, the dedicated memory regions 115 can be discrete (e.g., separated from one another).

The circuit execution unit 114 can interpret the quantum program 140 and generates, using an instruction element of the instruction element storage, a logical instruction that comprises a discrete higher-level instruction for the operation of the quantum program at the quantum computer system. That is, the circuit execution unit 114 can generally transform high-level quantum program code 142 into high-level logical instructions 160. As used herein, the term “high-level” can refer to upper hierarchy or affecting upper hierarchy less adjacent to quantum hardware, while the term “low-level” can refer to lower hierarchy or affecting lower hierarchy more adjacent to quantum hardware. As used herein, the term “logical instruction” can refer to a high-level instruction that is discrete and/or primitive, and which generally defines how to operate a quantum program without providing exact execution instructions. Accordingly, a logical instruction 160 can be provided absent specifying physical quantum gates, quantum hardware, and/or quantum hardware execution parameters, for example. Further, a logical instruction 160 is not associated with a physical clock or incremented integer of a physical clock.

The circuit execution unit 114 can comprise any suitable program, process, software, thread, hardware, code, data, metadata, and/or application programming interface that can allow for the circuit execution unit 114 (CEU) to perform its intended functions of interpreting and instruction generating.

The circuit execution unit 114 interfaces with one or more code control units 120 for provision of the logical instruction 160 for use by the code control unit 120 in generating a physical instruction 162 that comprises a lower-level instruction for execution of a specified quantum hardware 133 of the quantum computer system 107. As used herein, the term “physical instruction” can refer to an analog or non-primitive instruction including finer details for quantum hardware execution or quantum hardware-adjacent execution, such as specifying physical quantum gates, quantum hardware, and/or quantum hardware execution parameters, for example. Further, a physical instruction 162 is generally associated with and/or is to be implemented according to a physical clock or incremented integer of a physical clock.

By clean separation of the logical-level and physical-level instructions that each effect operation of the quantum program 140, adaptive, measurement-driven quantum protocols that are generally classically-driven, and which cannot be realized through static compilation alone, can be enabled.

In general, the non-limiting system 100 can employ any suitable method of communication (e.g., electronic, communicative, internet, infrared, fiber, etc.) to provide communication between the classical quantum circuit control system 101 and the quantum computer system 107, and/or between two or more networked LCUs 102.

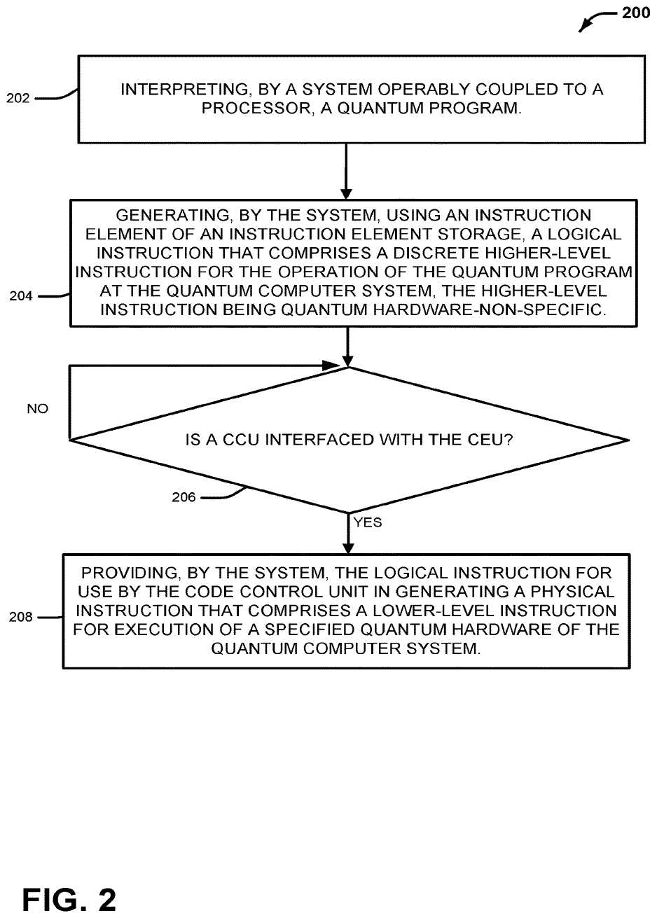

As a summary, referring next to FIG. 2, illustrated is a flow diagram of an example, non-limiting method 200 that can provide processes facilitating adaptation of an operation of a quantum program at a quantum computer system, to thereby provide execution of the quantum program at a quantum computer system 107, in accordance with one or more embodiments described herein, such as the non-limiting system 100 of FIG. 1. Repetitive description of like elements and/or processes employed in respective embodiments is omitted for sake of brevity.

At 202, the non-limiting method 200 can comprise interpreting, by a system operably coupled to a processor (e.g., circuit execution unit 114 operably coupled to a programmable processor 106), a quantum program (e.g., quantum program 140).

At 204, the non-limiting method 200 can comprise generating, by the system (e.g., circuit execution unit 114), using an instruction element (e.g., instruction element 154) of an instruction element storage (e.g., instruction element storage 152 of a memory 104), a logical instruction (e.g., logical instruction 160) that comprises a discrete higher-level instruction for the operation of the quantum program at the quantum computer system.

Optionally, at 206, the non-limiting method 200 can comprise determining, by the system (e.g., circuit execution unit 114), whether a code control unit (e.g., code control unit 120) is interfaced with the CEU 114, or vice versa. If yes, the non-limiting method 200 can proceed to step 208. If not, the non-limiting method 200 can proceed to repeat step 206 for or until the interfacing.

At 208, the non-limiting method 200 can comprise providing, by the system (e.g., circuit execution unit 114), the logical instruction for use by the code control unit in generating a physical instruction (e.g., physical instruction 162) that comprises a lower-level instruction for execution of a specified quantum hardware (e.g., quantum hardware 133) of the quantum computer system.

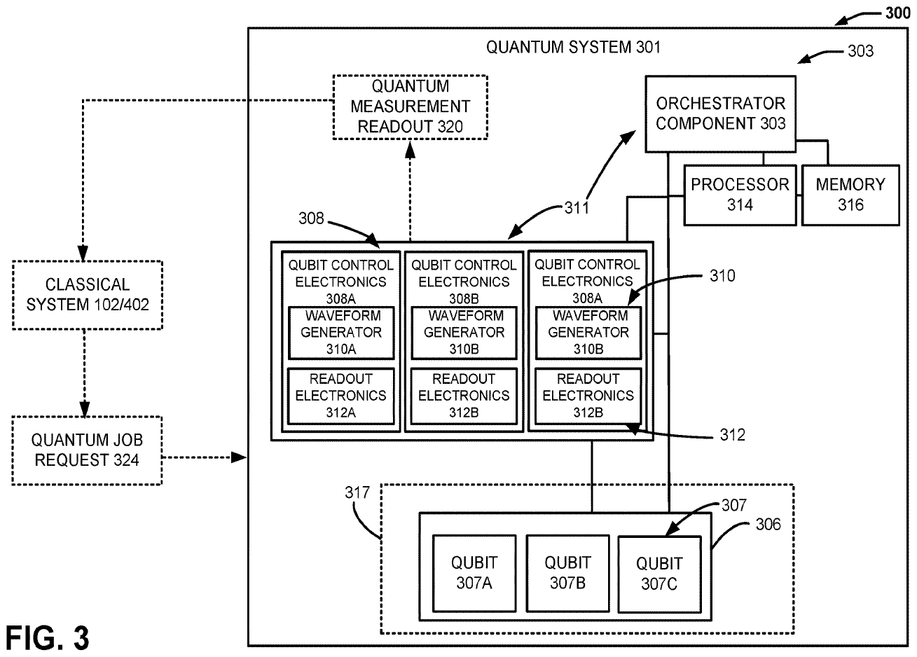

Discussion next turns to the quantum system 301 of FIG. 3, which can be employed as the quantum computer system 107 of FIG. 1. A measurement readout 320 (also herein referred to as a measurement output 320) can be obtained from the quantum system 301, which can correspond to the measurements 131. These measurements 131 are employed by the respective quantum circuit control systems 101, 401 (to be described below in detail) to adapt generated logical instructions 160, 460 and physical instructions 162, 462 during run-time of a quantum program 140, 440 at the quantum computer system 107, 301.

In particular, one or more embodiments described herein can include one or more devices, systems, and/or apparatuses that can provide a process to generate one or more waveforms or pulses for a quantum-based operation (e.g., using a quantum system having a quantum device comprising quantum hardware), such as for operating one or more qubits of the quantum hardware. Accordingly, at FIG. 3, illustrated is a block diagram of an example, non-limiting system 300 that can at least partially facilitate such a process. While referring here to one or more processes, facilitations and/or uses of the non-limiting system 100, description provided herein, both above and below, also can be relevant to one or more other non-limiting systems described herein, such as the non-limiting system 400 of FIG. 4, to be described in detail below.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits or qudits (e.g., d-dimensional qudit), physical circuit level components, high-level components, and/or high-level functions. The quantum circuity can generate physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readouts 320/measurements 131, can be responsive to a quantum job request 324 and associated input data, which can be based at least in part on the input data, quantum functions and/or quantum computations, and which can comprise one or more quantum circuits.

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for, and/or the like) a quantum job request 324 requesting execution of one or more quantum programs and/or requesting a physical qubit layout. The quantum job request 324 can be provided in any suitable format, such as a text format, binary format, and/or another suitable format. In one or more embodiments, the quantum job request 324 can be obtained by a component other than of the quantum system 301, such as a by a component of the classical quantum circuit control systems 102/402.

The orchestrator component 303 can determine mapping of one or more quantum logic circuits for executing a quantum program based on the quantum job request 324. In one or more embodiments, the orchestrator component 303 and/or quantum processor 306 can control the waveform generator 310 to generate one or more pulses, tones, waveforms and/or the like to affect one or more qubits 307, such as in response to the quantum job request 324, and/or in response to a resolution provided by the quantum circuit control system 401, to be described below.

In one or more embodiments, more than one orchestrator component 303 can be comprised by the quantum system 301. The one or more orchestrator components 303 can be employed to control one or more qubit control electronics 308. Thus, the one or more qubit control electronics 308A, 308B, and/or 308C can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312). In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 generally can cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can control application of such electro-magnetic signal by use of the various qubit control electronics 308.

The quantum processor 306 can be contained in a cryogenic environment, such as generated by a cryogenic environment 317, such as effected by a dilution refrigerator. Where one or more of the plurality of qubits 307 are superconducting qubits, cryogenic temperatures, such as about 4K or lower, can be employed for function of these one or more physical qubits 307.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description can refer to operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning next to FIG. 4, a non-limiting system 400 is illustrated that can comprise a quantum circuit control system 401 and the quantum system 301. Repetitive description of like elements and/or processes employed in respective embodiments is omitted for sake of brevity. Description relative to an embodiment of FIG. 4 can be applicable to an embodiment of FIG. 1. Likewise, description relative to an embodiment of FIG. 1 can be applicable to an embodiment of FIG. 4.

Generally, the non-limiting system 400 can address an existingly unaddressed aspect of how to handle high generation rate or frequency of physical quantum instructions in a top down basis. Generally, the quantum circuit control system 401 provides a logical circuit control architecture designed to enable efficient and scalable execution of logical quantum circuits on large-scale, fault-tolerant quantum computers. At the heart of the architecture is a logical control unit (LCU) that hosts one or more circuit execution units (CEUs). Each CEU executes a classical program that includes complex classical control flow and simultaneously generates logical-level quantum instructions. These logical-level quantum instructions are delivered to and/or otherwise obtained by one or more code control units (CCUs), which in turn generate physical-level quantum instructions and handle the physical-layer details of stabilizer management, syndrome cycles, hardware-specific gate decompositions, and scheduling of quantum hardware executions. This division of responsibilities provides a clean and technically-motivated separation between logical-layer control and physical-layer execution, enabling adaptive, measurement-driven quantum protocols that are generally classically-driven, which cannot be realized through static compilation alone.

Turning now to the quantum circuit control system 401, one or more communications between one or more components of the non-limiting system 400 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum circuit control system 401 can be associated with, such as accessible via, a cloud computing environment.

The quantum circuit control system 401 can comprise a plurality of components. The components can comprise a memory 404, processor 406, bus 405, acquiring engine 412, circuit execution unit 414, and/or CCU peripheral control 416. Using these components, and optionally using one or more outputs from the quantum system 301, the non-limiting system 400 generally can provide a primitive instruction interface 403 that can drive classical control-based adaptation of a quantum program 440 in run-time. As used herein, the term “primitive instruction interface” can refer to a high-level instruction interfaces, such as where a user can write a quantum code for a specific backend without having to explicitly manage some of the finer details. As used herein, the terms “real-time” and “run-time” can refer to provision during operation of a quantum program.

Discussion first turns briefly to the processor 406, memory 404, and bus 405 of the quantum circuit control system 401. For example, in one or more embodiments, the quantum circuit control system 401 can comprise the processor 406 (e.g., computer processing unit, microprocessor, classical processor, quantum processor and/or like processor). In one or more embodiments, a component associated with quantum circuit control system 401, as described herein with or without reference to the one or more figures of the one or more embodiments, can comprise one or more computer and/or machine readable, writable and/or executable components and/or instructions that can be executed by processor 406 to provide performance of one or more processes defined by such component and/or instruction.

In one or more embodiments, the processor 406 can be and/or comprise a programmable processor, such as a multi-core CPU, real-time CPU, or embedded microcontroller. The processor 406 can be programmable using any suitable interface communicatively couplable to the logical control unit 402. Programming can define a level of abstraction at which to provide logical instructions 460, what instruction elements 454 to employ, etc., without being limited thereto.

In one or more embodiments, the quantum circuit control system 401 can comprise the computer-readable memory 404 that can be operably connected to the processor 406. The memory 404 can store computer-executable instructions that, upon execution by the processor 406, can cause the processor 406 and/or one or more other components of the quantum circuit control system 401 (e.g., the acquiring 412, circuit execution unit 414, and/or CCU peripheral control 416) to perform one or more actions.

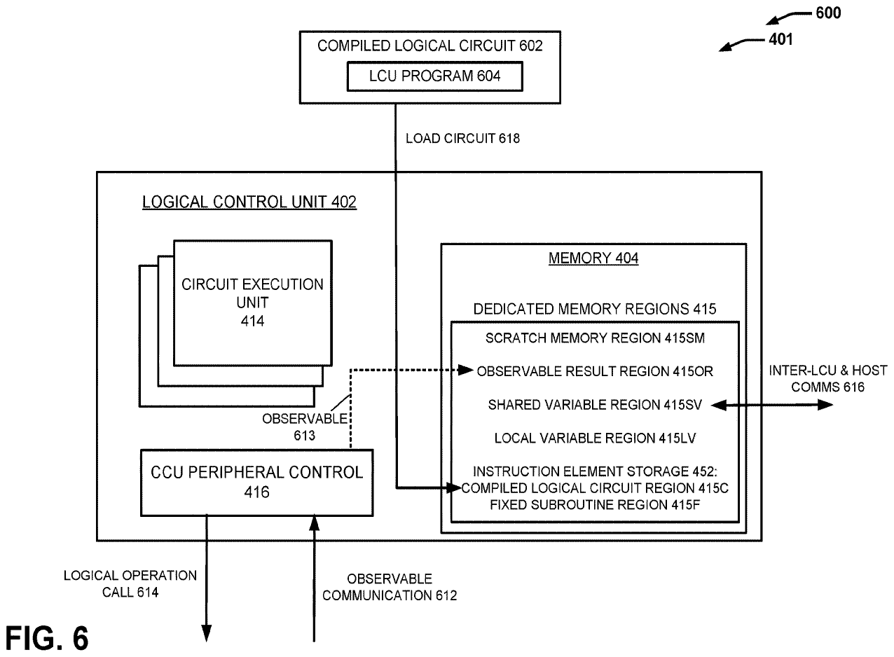

In one or more embodiments, the memory 404 comprises a plurality of dedicated memory regions 415 comprising at least an instruction element storage 452. One or more instruction elements 454 can be stored at the instruction element storage 452. As used herein, the dedicated memory regions 415 can be discrete (e.g., separated from one another). Further discussion of the memory 404 and of additional ones of the dedicated memory regions 415 will be provided below relative to FIG. 6.

The quantum circuit control system 401 and/or a component thereof as described herein, can be communicatively, electrically, operatively, optically and/or otherwise coupled to one another via a bus 405. Bus 405 can comprise one or more of a memory bus, memory controller, peripheral bus, external bus, local bus, quantum bus and/or another type of bus that can employ one or more bus architectures. One or more of these examples of bus 405 can be employed.

In one or more embodiments, the quantum circuit control system 401 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum circuit control system 401 and/or of the non-limiting system 400 can reside in the cloud, and/or can reside locally in a local computing environment (e.g., at a specified location).

In general, the non-limiting system 400 can employ any suitable method of communication (e.g., electronic, communicative, internet, infrared, fiber, etc.) to provide communication between the quantum circuit control system 401, the quantum system 301, and two or more networked LCUs 402, to be described below.

In addition to the processor 406 and/or memory 404 described above, the quantum circuit control system 401 can comprise one or more computer and/or machine readable, writable and/or executable components and/or instructions that, when executed by processor 406, can provide performance of one or more operations defined by such component and/or instruction.

Turning now first to the acquiring engine 412, this component can generally obtain the quantum program 440, or more particularly, the quantum program code 442. The obtaining can comprise finding, searching, uploading, downloading, acquiring, retrieving, etc. the quantum program 440 (e.g., data representing the quantum program 440) such as from a computer device associated with an administrating user entity that is communicatively coupled to the quantum circuit control system 401.

In one or more cases, the acquiring engine 412 can obtain an observable 430, such as a classical observable, logical observable, etc. directly from the quantum system 301, from a code control unit 420 assigned to or dedicated to the logical control unit 402, or by interfacing through an SPU 422.

In one or more cases, the acquiring engine 412 can obtain an instruction element 154, such as a compiled logical circuit, LCU program, fixed subroutine, etc.

Discussion turns next to the circuit execution unit 414 (CEU). In one or more embodiments, an LCU 402 can comprise and/or control one or more CEUs 414. As such, the one or more CEUs can be dedicated only to a particular LCU 402.

The circuit execution unit 414 can interpret the quantum program 440 and generates, using an instruction element 454 of the instruction element storage 452, a logical instruction 460 that comprises a discrete higher-level instruction for the operation of the quantum program 440 at the quantum computer system 301. That is, the circuit execution unit 414 can generally transform high-level quantum program code 442 into high-level logical instructions 460. As used herein, the term “high-level” can refer to upper hierarchy or affecting upper hierarchy less adjacent to quantum hardware, while the term “low-level” can refer to lower hierarchy or affecting lower hierarchy more adjacent to quantum hardware. As used herein, the term “logical instruction” can refer to a high-level instruction that is discrete and/or primitive, and which generally defines how to operate a quantum program without providing exact execution instructions. Accordingly, a logical instruction can be provided absent specifying physical quantum gates, quantum hardware, and/or quantum hardware execution parameters, for example. Further, a logical instruction is not associated with a physical clock or incremented integer of a physical clock.

The circuit execution unit 414 can comprise any suitable program, process, thread, software, hardware, code, data, metadata, and/or application programming interface that can allow for the circuit execution unit 414 (CEU) to perform its intended functions of interpreting and instruction generating.

The circuit execution unit 414 interfaces with one or more code control units 420 (CCUs) for provision of the logical instruction 460 for use by the code control unit 420 in generating a physical instruction 462 that comprises a lower-level instruction for execution of a specified quantum hardware 303 of the quantum computer system 301. As used herein, the term “physical instruction” can refer to an analog or non-primitive instruction including finer details for quantum hardware execution or quantum hardware-adjacent execution, such as specifying physical quantum gates, quantum hardware, and/or quantum hardware execution parameters, for example. Further, a physical instruction is generally associated with and/or is to be implemented according to a physical clock or incremented integer of a physical clock.

It is noted that separate from the primitive instruction, in one or more cases, a dedicated memory region 415 can be loaded, such as at system setup time, with one or more subroutines that operate at the logical level (e.g., higher-level) but nonetheless abstract some of the details of lower-level (e.g., physical level) instructions.

By majoritively clean separation of the logical-level instructions and physical-level instructions that each affect and effect operation of the quantum program 440, adaptive, measurement-driven quantum protocols that are generally classically-driven, and which cannot be realized through static compilation alone, can be enabled.

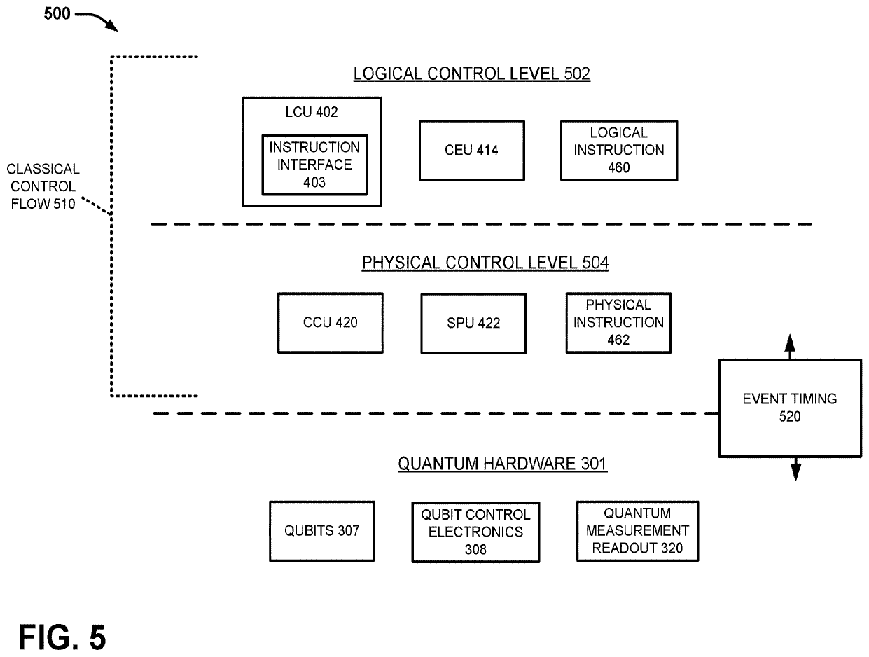

To further define operation of an LCU 402 and CEU 414, discussion next turns to FIG. 5, illustrating a high-level, schematic layout 500 of the quantum circuit control system 401, while still referring to FIG. 4. At FIG. 5, the operation of the LCU 402 is illustrated as comprising a separated logical control level 502 and physical control level 504. While both logical control and physical control can be performed classically as part of a classical control flow 510, as illustrated, and as noted above, the logical control level 402 does not employ or operate according to event timing 520. That is, the logical control level 402, including the LCU 402 and CEU 414 are agnostic to event timing, such as event timing 520. Such event timing 520 can comprise physical clock timing, SPU timing, and/or timing of physical stimulus to quantum hardware.

That is, the logical level of instructions, comprising the logical instructions 460, does not correspond to qubits changing state but rather to a series of operations defining how to instruction execution of the physical qubits (e.g., physical qubits 307). Thus, while the instruction of execution of physical qubits by a CCU 420 can be operated according to event timing 520, and thus employ greater complexity and bandwidth for physical instruction 462 generation, the LCU 402 can generally be programmed to be ignorant of event timing 520. As used herein, event timing 520 can refer to physical clock timing, SPU timing, and/or timing of physical stimulus to quantum hardware.

The LCU 402 can be programed to instruct order of operations and use of dependencies (e.g., shared variables, local variables, observable results, etc.) but does not have to reason regarding time (e.g., event timing 520). This can simplify a distribution network for the event timing 520 by omitting the LCUs 402 and/or CEUS 414. Put another way, while an LCU 402 does not have to be a real-time system, by relaxing operating requirements for the LCU 402, the LCU 402 can perform classical operations that subsequently cause real-time operation of the quantum program 440. The LCU 402 can thus employ less bandwidth for operating per controlled CCU 420 than is employed by any one controlled CCU 420 (e.g., CCU 420 dedicated to a respective LCU 402).

To even further define operation of an LCU 402 and CEU 414, discussion turns next to FIG. 6, illustrating is a lower-level, schematic layout 600 of a logical control unit 402 of the quantum circuit control system 401, while still referring to FIG. 4.

As illustrated at FIG. 6, the memory 404 can comprise a plurality of dedicated memory regions 415. These can comprise a scratch memory region 415SM, observable result region 415OR, shared variable region 415SV, local variable region 415LV and instruction element storage 452. The instruction element storage 452 can comprise dedicated regions of a compiled logical circuit region 415C and a fixed subroutine region 415F. By organizing memory into defined regions with explicit semantics, the architecture avoids ambiguity in data handling and provides concrete structural support for the CEU's decision-making processes.

For example, the scratch memory region 415SM can provide space, such as temporary registers, for intermediate communication performed by the respective LCU 402 processor 406 and/or dedicated CEUs 414. The observable result region 415OR can be loaded by the acquiring engine 412 with observables 613, which can be obtained by the LCU through an observable communication 612, such as from a CCU 420 or more directly from a component of the quantum computer system 301.

The shared variable region 415SV can be interconnected to one or more other LCUs 402, such as by an inter-LCU and/or host communication 616. In this way, a CEU 414 and/or CCU 420 can access the dedicated memory regions to change behavior, such as based on a trigger, specified check, change in data/metadata tag, notification, etc. Regarding the CCUs 420, this can allow for ease of reference by the CCUs 420 without use of significant local memory readout for the CCUs 420, as a large amount of processing can occur at the CCUs 420 without such CCUs 420 performing work on their dedicated, shared memory.

The local variable region 415LV can comprise variable that are not shared and may only be employed for one or more particular CEUs 414.

The compiled logical circuit region 415C can comprise any one or more compiled logical circuits 602, comprising any one or more LCU programs 604 which can be provided by a user entity (e.g., via computer device associated therewith) and/or obtained and stored by the acquiring engine 412 by way of a load circuit 618, for example. As used herein, a “compiled logical circuit” can refer to a program provided by a user entity that changes between intended applications of the quantum computer.

The compiled logical circuit region 415C storage can allow for pre-generated program portions or logical circuit portions to be employed in more rapidly and/or efficiently generating the logical instructions 460, which can comprise the logical circuits. Likewise, such storage can allow for offloading of up-front and time-consuming processes from either a user entity and/or the quantum circuit control system 401 more generally, speeding up processing and allowing higher-speed physical instruction generation to occur efficiently and in a timely manner needed to operate physical qubits of a near-term or future quantum computer system.

Likewise, the fixed subroutine region 415F can comprise any one or more fixed subroutines which can be provided by a user entity (e.g., via computer device associated therewith) and/or obtained and stored by the acquiring engine 412. As used herein, a “fixed subroutine” can refer to a subroutine that stores low-level programs/subroutines that are loaded at system deployment (e.g., by an administrating entity of the quantum circuit control system 401) and that define common behavior used in logical circuits. For example, a logical circuit can comprise an instruction having a clear logical definition, but the behavior of the instruction can be defined by, or depend upon, a stored fixed subroutine.

This fixed subroutine region 415F storage can allow for pre-generated fixed subroutines to be employed in more rapidly and/or efficiently generating the logical instructions 460, which can comprise the logical circuits. Likewise, such storage can allow for offloading of up-front and time-consuming processes from either a user entity and/or the quantum circuit control system 401 more generally, speeding up processing and allowing higher-speed physical instruction generation to occur efficiently and in a timely manner needed to operate physical qubits of a near-term or future quantum computer system.

The CEU 414 itself comprises a classical control-flow interpreter that processes a user-provided or compiler-generated classical program (e.g., quantum program 440), which can describe a logical circuit. As used herein, the term “logical circuit” can refer to a high-level quantum circuit specification of an intended action of a quantum circuit.

This interpreter reads observable results from the memory 404, updates both local and shared variables (e.g., at the shared variable region 415SV and the local variable region 415LV), evaluates branching conditions, and/or selects subsequent logical or primitive instructions (e.g., logical instructions 460) to generate, make available, transmit, etc. Such run-time adaptation can be useful for protocols like magic-state distillation retries, adaptive basis selection for Clifford corrections, inter-module logical operations that require coordination across CCUs 414, and/or routing decisions in systems with dynamically varying resource availability. By executing these control-flow decisions at run-time rather than at compile-time, the CEU 414 can enable execution paths that would otherwise be infeasible, too costly, or too hardware-specific to precompute.

It is noted that as used herein, the term “compile-time” refers to a time period (e.g., of indeterminate length) during which a circuit is prepared for execution (e.g., by a computer program).

Logical-circuit generation within the CEU 414 can occur entirely at compile-time or can be performed partially or fully at run-time, depending on the structure of the quantum algorithm and the observed measurement results. As noted above, the CEU 414 translates portions of a high-level quantum program 440 into logical quantum circuits comprising higher-granularity logical operations, such as logical Clifford gates, logical Pauli measurements, and inter-module operations spanning multiple code blocks. As execution proceeds, the CEU 414 can generate new logical instructions 460 based on measurement outcomes, updated variable states, or information shared across LCUs 402. This dynamic generation provides a concrete mechanism for supporting non-deterministic workflows, fault-tolerant recovery sequences, and/or data-dependent algorithmic paths without requiring extensive recompilation or hardware-specific microcode.

The logical instructions 460 can be made available to and/or transmitted to a CCU 420 by way of a logical operation call 614 provided by a CCU peripheral control 416. The CCU peripheral control 416 generally handles (network) communication with the connected CCUs 420. The CCU peripheral control 416 sends logical operations that one or more CCUs 420 are to perform (e.g., via logical operation call 614 communications) and receives observable results (e.g., observables 613 via observable communication 612) from CCUs 420. The CCU peripheral control 416 can store and/or direct storage of the observables 613 in the appropriate memory location of the memory 404 (e.g., the observable result region 415OR of the dedicated memory regions 415).

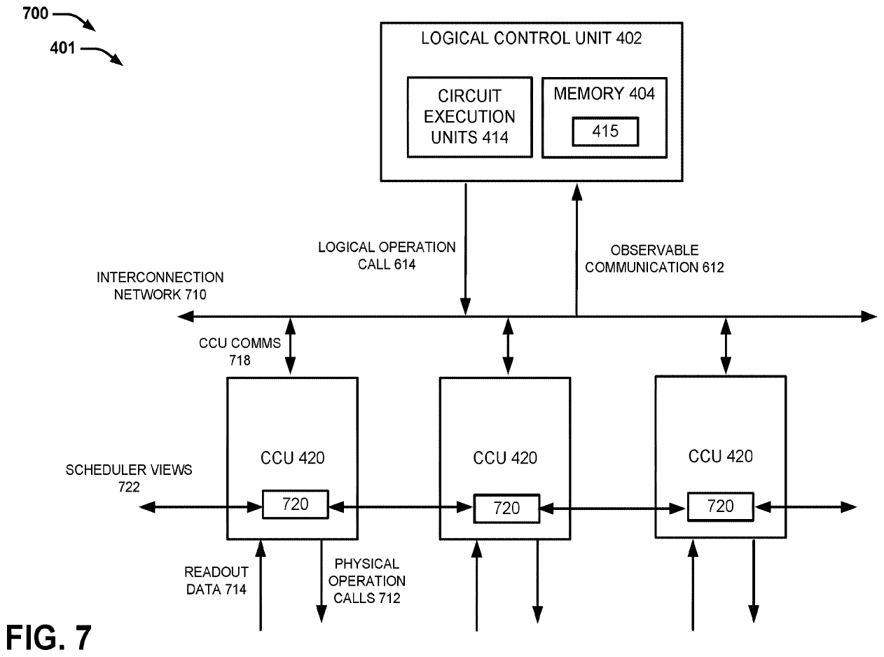

Turning next to FIG. 7, and still referring to FIG. 4, illustrated is a more-detailed schematic 700 of the quantum circuit control system 401, including not only the LCU 402 and its one or more CEUs 414, but also including one or more code control units 420 (CCUs). It is noted that while FIGS. 4 and 7 illustrate the CCUs 420 as being comprised by the quantum circuit control system 401, in one or more embodiments, the quantum circuit control system 401 can comprise only the logical control level 502, with the physical control level 504 being separate from, but communicatively couplable with the logical control level 502.

As illustrated at FIG. 7, any one CEU 414 can be assigned to one or more code control units 420 (CCUs), and/or one or more CCUs 420 can be assigned and/or dedicated to a particular CEU 14. As described above, a CCU 420 operates at the physical control level 504 of the quantum circuit control system 401, operating according to event timing 520, and generating physical instructions 462 for executing particular aspects of quantum hardware 303.

Communication between the CEU 414 and the dedicated CCUs 420 can occur through a primitive instruction interface, such as the illustrated interconnection network 710 and associated CCU comms 718. Using the interconnection network 710, the LCU 402 can obtain observable communications 612 from the CCUs 420 and/or transmit (or make available) logical operation calls 614 comprising the logical instructions 460. These logical operation calls 614 can comprise operations such as logical Pauli measurements, both intra-module and inter-module joint measurements, magic-state preparation and verification calls, syndrome-cycle-framed operations, and/or routing primitives, without being limited thereto. Each primitive represents a higher-level, hardware-aligned abstraction that the CCU 420 decomposes into multiple physical-layer steps, such as ancilla initialization, stabilizer checks, syndrome cycles, and/or post-processing, without being limited thereto. That is, a CCU 420 can satisfy the soft real-time constraints of a logical instruction 460 through syndrome-cycle timing, coordinated inter-module logical measurements, and/or other timing-critical fault-tolerant operations. To facilitate such scheduling, each CCU 420 can comprise a scheduler 720 that can communicate with one another to provide scheduler views.

Because a CCU 420 autonomously handles these complex sequences, the CEU 414 need only transmit occasional high-level primitives, which drastically lowers the average instruction rate relative to the physical operation rate. Put another way, the lower-complexity interface, comprising the circuit execution unit 414, generates logical instructions 460 at a first average instruction rate that is less than a second average instruction rate at which the code control units 420 generate physical instructions 462. As a result, network bandwidth requirements are reduced, the CEU's 414 real-time burden is minimized, and/or the architecture can scale to systems involving hundreds or even thousands of CCUs 420.

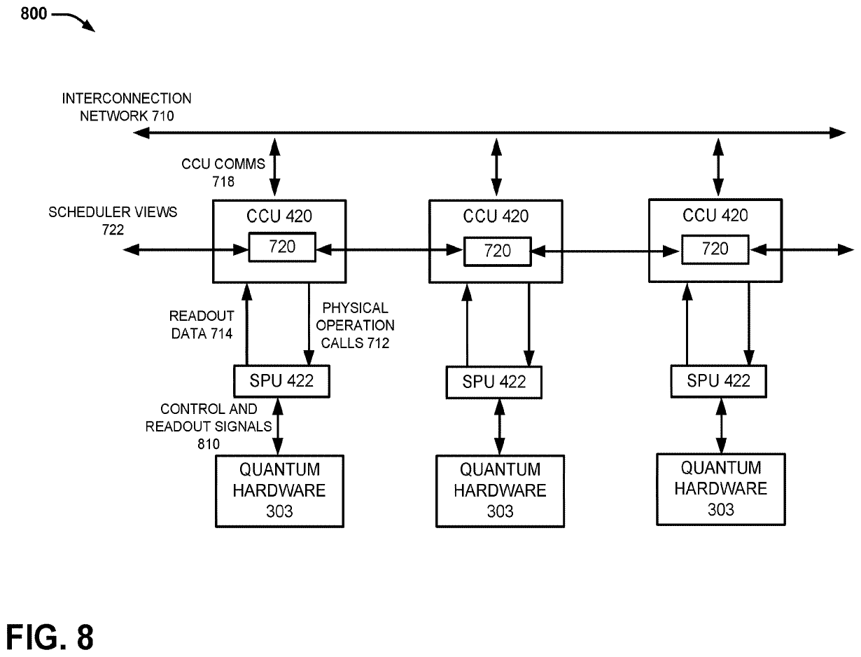

Looking to FIG. 8, and still referring to FIG. 4, illustrated is a schematic 800. Particularly illustrated are a plurality of CCUs 420 that can control a plurality of respective special processing units 422 (SPUs) to thereby send control and readout signals 810 to specific instances of quantum hardware 303 to thereby execute and/or operate the physical quantum hardware 303, such as according to a schedule defined by event timing 520. It is noted that while at least the CCUs 420 and SPUs 422 are illustrated as being comprised by the quantum circuit control system 401 at FIG. 4, in one or more cases, the SPUs 422, or the CCUs 420 and SPUs 422, can be external to the quantum circuit control system 401, but communicatively couplable to and/or with the quantum circuit control system 401.

As illustrated at FIG. 8, the CCUs 420 and SPUs 422 can communicate with one another to send readout data 714 (e.g., comprising observables or other readout data) from the quantum system 301 to the CCUs 420. Such communication also can provide for transmission or making available the physical instructions 462 through use of physical operation calls 712. An SPU 422 can be dedicated to a particular aspect of quantum hardware 303. Alternatively, multiple SPUs 422 can control any individual aspect of quantum hardware 303, as needed to execute a quantum program 440. For example, an SPU 422 can comprise an application-specific integrated circuit (ASIC) that can send a waveform, pulse, etc. to the quantum hardware 303.

In one or more cases, multiple CCUs 420 can control a same SPU 422, and/or multiple SPUs 422 can control a same quantum hardware aspect 303 (e.g., pulse generator). Likewise, a single quantum hardware aspect 303 can send signals to one or more SPUs 422.

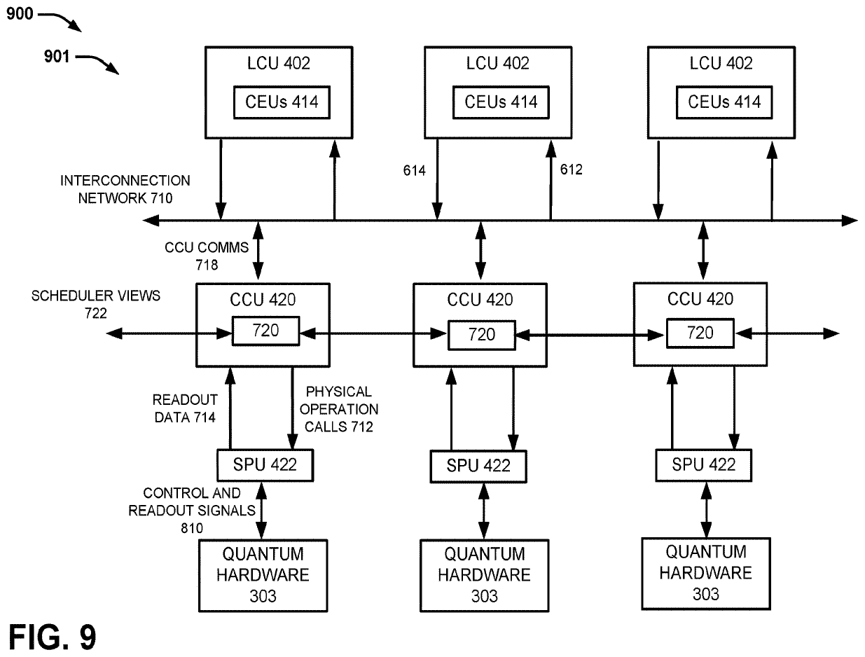

Referring next to FIG. 9, and still referring to FIG. 4, illustrated is a schematic 900 comprising an alternative quantum circuit control system 901. Discussion above relative to the quantum circuit control system 401 can equally apply to the quantum circuit control system 901, and discussion above is not repeated for sake of brevity.

Different from the quantum circuit control system 401, the quantum circuit control system 901 comprises a network of interconnected LCUs 402 for use in operating a common (e.g., same) quantum program 440 by each of the LCUs 402 in concert with one another. The LCUs 402 can intercommunicate via the interconnection network 710. As noted above, the interconnection network 710 can comprise any suitable communication medium, hardware, and/or software, such as those described either above or below, without being limited thereto.

For example, for large quantum computers, up to approximately 500 physical qubits can be assigned to and/or controlled by a CCU 420. An LCU 402 can generally control up to approximately 1000 CCUs. However, plural LCUs 402 can be employed for increased scaling or for reduced LCU to CCU ration. For example, multiple LCUs 402 can be deployed and interconnected through a high-performance communication fabric (e.g., the interconnection network 710). This distributed arrangement can enable parallel execution of logical circuits across distinct regions of the hardware, with each LCU 402 comprising one or more respective CEUs 414, and with each LCU 402 handling a subset of CCUs 420. Local communication between LCUs 402 controlling neighboring modules can be optimized for low latency, while the broader global interconnect provides shared-state propagation, synchronization, and coordination for operations spanning multiple logical modules. Shared variables maintained across LCUs 402 (e.g., via use of the shared variable regions 415SV of the respective dedicated memory regions 415 of the LCUs 402) can support coordination for joint logical measurements, distributed entanglement generation, dynamic load balancing, and/or deadlock-free resource negotiation. This multi-LCU architecture further enhances scalability of the systems described herein by reducing global broadcast pressure and enabling localized high-throughput control.

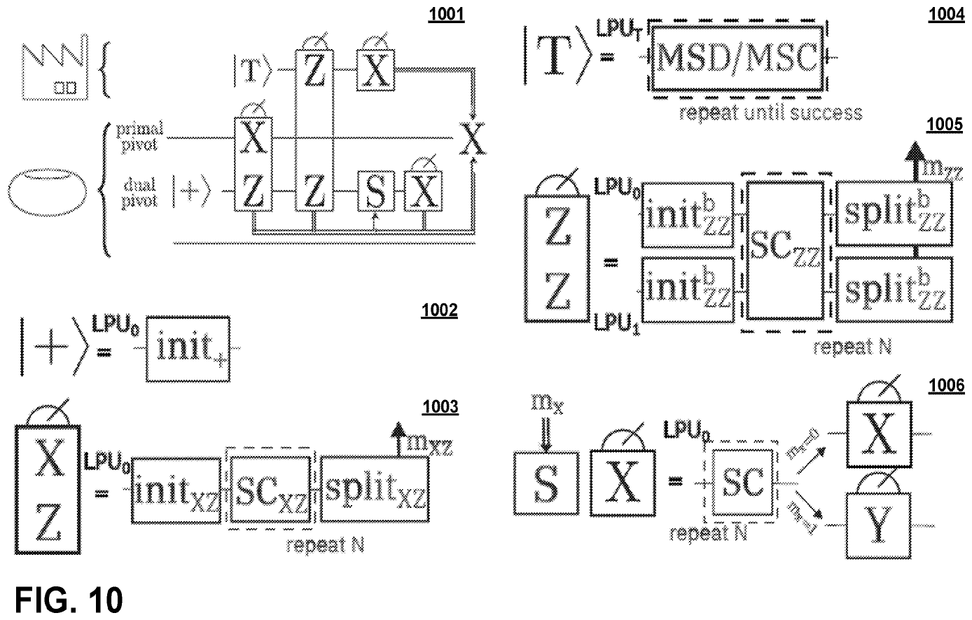

Discussion next briefly refers to FIG. 10 illustrating different exemplary quantum circuits that can be facilitated by generation of one or more logical instructions 460 by one or more respective CEUs 414.

Looking first to a first example circuit 1001, in magic state injection, a Clifford X(π/2) correction is conditional on a ZX measurement result. To determine the right basis measurement at the end, the LCU receives a measurement result from the quantum system and/or from a CCU and sends a correct basis to measure, e.g., as a logical instruction, to the CCU or to a different CCU.

At a second example circuit 1002, the LCU can send an instruction to the CCU that initializes the logical processing unit, which is an ancillary system, in the |+> state.

At a third example circuit 1003, the primitive instruction of a Pauli measurement consists of many lower-level instructions that are executed on the CCU, such as initializing ancillas, syndrome checks, and a subsequent splitting of codes. The LCU is not aware of this decomposition and only obtains the measurement result, mx. This is an example of a logical-level abstraction at which the LCU operates as compared to the physical-level of abstraction at which the CCU operates.

Looking next to a fourth example circuit 1004, a repeatable quantum circuit is illustrated. The process of magic state distillation can succeed or fail. To successfully produce a magic state, logical conditional logic is employed which repeats the magic state distillation process until it has succeeded.

Regarding a fifth example circuit 1005, a logical measurement between two code modules (e.g., at quantum hardware 303) requires the coordination of multiple CCUs. One or more CEUs issue related instructions to their assigned CCUs that are to be performed simultaneously. The exact implementation is hidden from or not employed by the CEUs, but the logical-level of instruction can comprise directing the simultaneous performance of the logical instructions.

Referring last to a sixth example circuit 1006, a conditional Clifford operation, dependent on measurement result M_{zx}, can be realized by an LCU through a designated CEU thereof selecting an appropriate basis measurement, e.g., Z/Y in the fifth example circuit 1005. With respect to the conditional Clifford operation, a CCU assigned to the CEU will automatically insert syndrome cycles until it receives the appropriate logical instruction from the CEU.

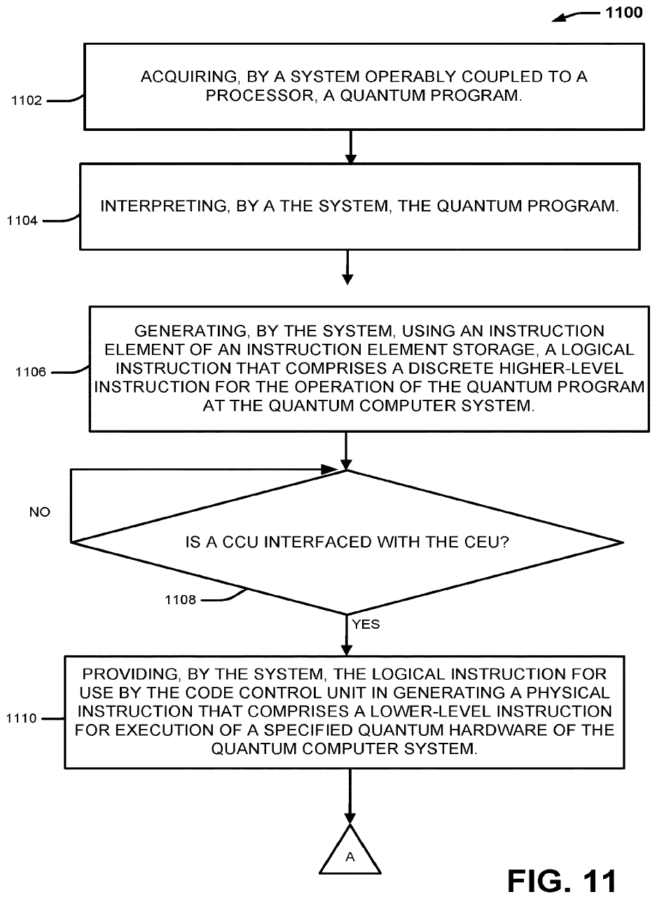

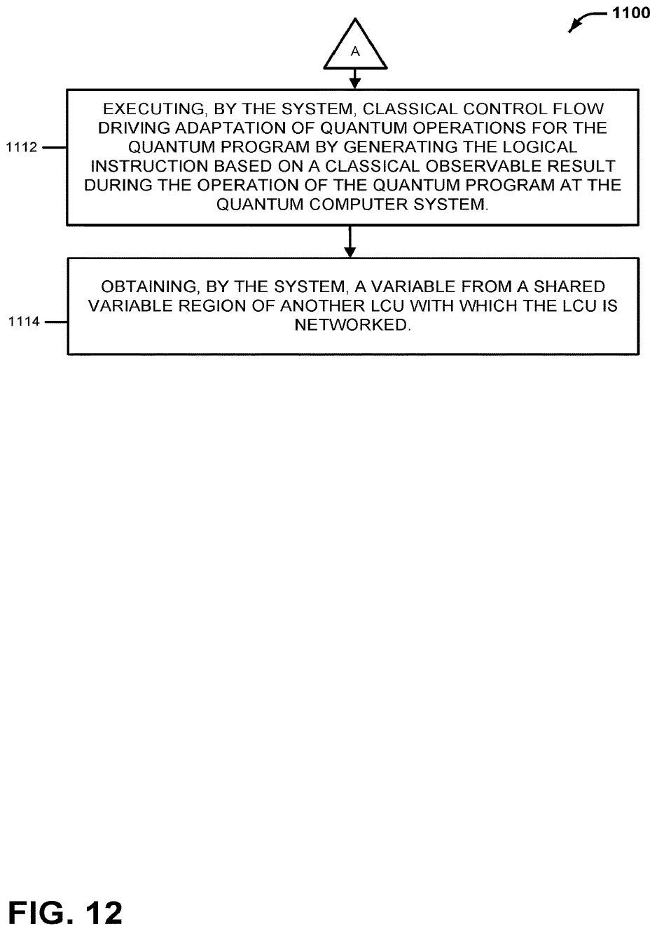

As a summary of the above-described processes, referring next to FIGS. 11 and 12, illustrated is a flow diagram. The flow diagram provides an example, non-limiting method 1100 that can provide processes facilitating dynamic quantum program execution during run-time, in accordance with one or more embodiments described herein, such as the non-limiting system 400 of FIG. 4. While the non-limiting method 1100 is described relative to the non-limiting system 400 of FIG. 4, the non-limiting method 1100 can be applicable also to other systems described herein, such as the non-limiting system 100 of FIG. 1. Repetitive description of like elements and/or processes employed in respective embodiments is omitted for sake of brevity.

At 1102, the non-limiting method 1100 can comprise acquiring, by a system operably coupled to a processor (e.g., acquiring engine 412 operably coupled to a programmable processor 406), a quantum program (e.g., quantum program 440).

At 1104, the non-limiting method 1100 can comprise interpreting, by a system operably coupled to a processor (e.g., circuit execution unit coupled to a programmable processor 406), a quantum program (e.g., quantum program 440). For example, the CEU can break the quantum program code 442 down into usable segments.

At 1106, the non-limiting method 1100 can comprise generating, by the system (e.g., circuit execution unit 414), using an instruction element (e.g., instruction element 454) of an instruction element storage (e.g., instruction element storage 452 of a memory 404), a logical instruction (e.g., logical instruction 460) that comprises a discrete higher-level instruction for the operation of the quantum program at the quantum computer system.

Optionally, at 1108, the non-limiting method 1100 can comprise determining, by the system (e.g., circuit execution unit 414), whether a code control unit (e.g., code control unit 420) is interfaced with the CEU 414. If yes, the non-limiting method 1100 can proceed to step 1110. If not, the non-limiting method 1100 can proceed to repeat step 1108 for the interfacing.

At 1110, the non-limiting method 1100 can comprise providing, by the system (e.g., circuit execution unit 414), the logical instruction for use by the code control unit in generating a physical instruction (e.g., physical instruction 462) that comprises a lower-level instruction for execution of a specified quantum hardware (e.g., quantum hardware e03) of the quantum computer system.

At 1112, the non-limiting method 1100 can comprise executing, by the system (e.g., CEU 414), classical control flow driving adaptation of quantum operations for the quantum program by generating the logical instruction based on a classical observable result during the operation of the quantum program at the quantum computer system.

At 1114, the non-limiting method 1100 can comprise obtaining, by the system (e.g., CEU 414), a variable from a shared variable region of another LCU with which the LCU is networked.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the innovations described herein employ logical-level classically-operated interface, explicit memory organization, control-unit structure, and inter-unit communication patterns directly correspond to the architectural challenges presented by large-scale quantum hardware and provide non-abstract, technically-grounded solutions. The one or more embodiments described herein system comprise a logical control unit (LCU) 102, 402 operably couplable to a quantum computer system 107, 301 and operating an instruction interface 103, 403 for logical control over an operation of a quantum program 140, 440 at the quantum computer system 107, 301. The LCU 102, 402 comprises a programmable processor 106, 406, a memory 104, 404, operably coupled to the programable processor 106, 406 and comprising dedicated memory regions 115, 415 comprising an instruction element storage 152, 452, and a circuit execution unit (CEU) 114, 414 that interprets the quantum program 140, 440 and generates, using an instruction element 154, 454 of the instruction element storage 152, 452, a logical instruction 160, 460 that comprises a discrete higher-level instruction for the operation of the quantum program 140, 440 at the quantum computer system 107, 301. The CEU 114, 414 interfaces with a code control unit (CCU) 120, 420 for provision of the logical instruction 160, 40 for use by the CCU 120, 420 in generating a physical instruction 162, 462 that comprises a lower-level instruction for execution of a specified quantum hardware 133, 303 of the quantum computer system 107, 301.

This architecture provides multiple benefits over existing frameworks. For example, the one or more embodiments described herein can provide transformation of highest-level, user entity-provided quantum program direction (e.g., quantum program code) into high-level, logical instructions, and optionally into lower-level, physical instructions, using a primitive instruction interface. The primitive instruction interface can allow a high-level user entity to write quantum algorithms without specifically considering physical clock scheduling and/or quantum hardware details, such as specific quantum hardware operations. Thus, the primitive instruction interface of the logical control unit (LCU), including the circuit execution unit (CEU), can control a higher abstraction level without specifying particular quantum gates, signal intensities, phase or wave parameters, etc. The hierarchical communication can allow for further reduction in processing by allowing multiple interconnected (e.g., networked) logical control units to together form primitive instruction management for operation of a quantum program or for operation of a portion of a quantum program.

Still another benefit can comprise fewer constraints being inherently associated with the one or more systems described herein, such as with respect to what types of quantum programs can be executed by the one or more systems. That is, use of the one or more systems described herein desirably avoid direct programming of physical qubit executions which have a high instruction rate. Instead, classical computing, which operates one or more orders of magnitude more slowly, can be employed to, at a high level, provide a road map or outline via lower-frequency/lower-rate logical instruction generation to thereby control the higher-frequency/higher rate generation of physical instructions. As a result, a quantum program can be operated without direct programming of all or any physical qubit instructions, which can allow for more efficient, easier, faster, and/or less complex quantum program operation facilitation. This can also allow less-experienced user entities to operation a complex quantum program without directly facilitating the associated, complex quantum program operation. Furthermore, this type of operation provided by the one or more embodiments described herein can make it easier to build or engineer a specific hierarchically-distributed, multi-LCU quantum operation control network because no one component operates at every level of abstraction or quantum hardware-adjacency.

These benefits directly result in practical applications of the one or more embodiments described herein. Beyond the noted practical application of increase in speed of execution of quantum hardware for near-term or future, fault-tolerant quantum computer systems, several other practical applications arise from the disclosed frameworks. For example, because the disclosed frameworks do not depend on physical clock operation for LCU and/or CEU operation, while the instruction of execution of physical qubits by a CCU can be operated according to a physical clock, and thus employ greater complexity and bandwidth for physical instruction generation, the LCU can generally be programmed to be ignorant of physical clocks. The LCU can be programed to instruct order of operations and use of dependencies (e.g., shared variables, local variables, observable results, etc.) but does not have to reason regarding time. This can simplify a distribution network for the physical clock as omitting the LCUs and/or CEUS. Put another way, while an LCU does not have to be a real-time system, by relaxing operating requirements for the LCU, the LCU can perform classical operations that subsequently cause real-time operation of the quantum program.

For another practical application example, during an operation of a quantum program, the processes running on/at an LCU can call fixed subroutines, observable results local variables, or shared variables, without being limited thereto, that are separately stored at separate dedicated storage regions of a memory of the LCU. The observable results, such as bit values, can be obtained from the quantum computer system or from one or more CCUs for storage at the LCUs. Accordingly, these different stored aspects can be directly written to assigned memory addresses at an LCU. In this way, a CEU and/or CCU can access the dedicated memory regions to change behavior, such as based on a trigger, specified check, change in data/metadata tag, notification, etc. Regarding the CCUs, this can allow for ease of reference by the CCUs without use of significant local memory readout for the CCUs, as a large amount of processing can occur at the CCUs without such CCUs performing work on their dedicated, shared memory. Regarding the CEUs, this can allow such aspects to be operated as processes, components, engines, etc. with the same or similar benefits including separate readout memory access.

Moreover, embodiments described herein are not limited to use of a single LCU. As still another practical application example, the one or more frameworks described herein can provide use of a distributed CEUs/LCUs network comprising multiple LCUs, with each LCU comprising and/or controlling one or more dedicated CEUs (e.g., CEUs assigned to a respective LCU). Multi-CCU coordination can be provided per CEU, with each CEU controlling one or more dedicated CCUs (e.g., CCUs assigned to a respective CEU). CCUs can each control one or more special processing units (SPUs) that directly execute operations at physical qubits. In one or more cases, SPUs can be stored at a cryogenic environment, although one or more can be stored external to a cryogenic environment. Multiple CCUs can control a same SPU, and multiple SPUs can control a same quantum hardware aspect (e.g., pulse generator). As noted above, this type of hierarchically-distributed, multi-LCU quantum operation control network can provide easier operation, engineering, and/or manufacture thereof because no one component operates at every level of abstraction or quantum hardware-adjacency.

As another practical application, real-time circuit execution unit (CEU) operation can be performed that drives run-time adaptation of a quantum program. That is, generation of a logical instruction by a CEU can allow for the LCU to provide dynamic (e.g., updatable, changeable, or adaptable) classical control flow of quantum operations during operation of a quantum program at a quantum computer system. As such, lower bandwidth, less complex, and/or off-quantum system classical computing can drive quantum operation at a quantum computer system. No prior framework is known to separate classical, logical-level instruction generation and classical, physical-level instruction generation to enable real-time circuit execution at the speeds and bandwidth required for near-term or future, fault-tolerant quantum computer systems.

Put another way, the one or more embodiments described herein can provide useful and practical applications of computers, thus providing enhanced (e.g., improved and/or optimized), dynamic, and classically-controlled quantum program operation, as compared to existing frameworks for the same.

It follows that one or more embodiments described herein can be, in one or more embodiments, inherently and/or inextricably tied to computer technology and cannot be equally practicably implemented in a sensible way outside of a computing environment. For example, one or more processes performed by one or more embodiments described herein can more efficiently, and even more feasibly, provide quantum program instruction generation and/or execution, as compared to existing systems and/or techniques unable to provide such efficiencies and/or complexities.

It also follows that one or more embodiments described herein can employ hardware and/or software to solve problems that are highly technical, that are not abstract, and that cannot be performed as a set of mental acts by a human. For example, a human, or even thousands of humans, cannot efficiently, accurately, and/or effectively automatically or even partially automatically access information output from a quantum system relative to check qubits and/or other measurement readouts, and/or operate a classical quantum program operation and adaptation system, as the one or more embodiments described herein can provide these processes. Moreover, neither can the human mind nor a human with pen and paper conduct these processes, as conducted by one or more embodiments described herein.

Overall, such computerized tools constitute a concrete and tangible technical improvement in the fields of quantum program operation and/or quantum hardware instruction generation. Put another way, the one or more embodiments described herein can thus achieve substantial improvements to functioning of quantum hardware by enabling more accurate, efficient, reliable, run-time-relevant instructions than existing frameworks. These improvements are rooted in the separable generation of logical-level instructions versus physical-level instructions provided by a classically-operated network of one or more logical control units (LCUs) that each employ dedicated memory storage regions and comprise or control one or more specified circuit execution units (CEUs).

That is, processes of embodiments discussed herein, including driving run-time adaptation of operation of a quantum program through classical control, during operation of the quantum program, demonstrate a direct tie to hardware functionality and establishes the subject matter discussed herein as a practical technological improvement rather than a theoretical or mathematical abstraction. Put still another way, embodiments described herein do not merely perform abstract mathematical calculations, or merely input data and output data, but rather implement a coordinated, engineered process involving physical quantum hardware (e.g., qubit arrays, waveform generators, measurement readout electronics), classical computational components, and instruction interfaces, that together form a hybrid system.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

One or more embodiments described herein can be employed in scale, such as to perform two or more of the above-noted processes at least partially in parallel with one another. In one or more cases, one or more same and/or different ones of the above-noted processes can be performed at a same time as one another. Further, two or more of these above-noted processes can be at least partially operated at a same time as one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

To provide additional summary, a listing of embodiments and features thereof is provided.

A system, comprises a logical control unit operably couplable to a quantum computer system and operating an instruction interface with the quantum computer system for logical control over an operation of a quantum program at the quantum computer system, the logical control unit comprising a programmable processor, a memory, operably coupled to the programable processor and comprising dedicated memory regions comprising an instruction element storage, and a circuit execution unit that interprets the quantum program and generates, using an instruction element of the instruction element storage, a logical instruction that comprises a discrete higher-level instruction for the operation of the quantum program at the quantum computer system, wherein the circuit execution unit interfaces with a code control unit for provision of the logical instruction for use by the code control unit in generating a physical instruction that comprises a lower-level instruction for execution of a specified quantum hardware of the quantum computer system.

Regarding the system of the preceding paragraph, the circuit execution unit executes classical control flow driving adaptation of quantum operations for the quantum program by generating the logical instruction during the operation of the quantum program at the quantum computer system.

Regarding the system of any preceding paragraph, operations performed by the logical control unit and the circuit execution unit, comprising the interpreting and interfacing, are agnostic to event timing by which the code control unit operates.

Regarding the system of any preceding paragraph, the instruction interface operated by the logical control unit comprises a lower-complexity interface requiring lower bandwidth for operating per code control unit, comprising the code control unit, than is employed by the code control unit.

Regarding the system of any preceding paragraph, the lower-complexity interface, comprising the circuit execution unit, generates logical instructions, comprising the logical instruction, at a first average instruction rate that is less than a second average instruction rate at which the code control unit generates physical instructions, comprising the physical instruction.

Regarding the system of any preceding paragraph, the logical control unit further comprises an acquiring engine that obtains a classical observable result defining a quantum measurement readout of the quantum computer system and that stores the classical observable result at an observable result region of the dedicated memory regions, wherein the circuit execution unit executes classical control flow driving adaptation of quantum operations for the quantum program by generating the logical instruction based on the classical observable result during the operation of the quantum program at the quantum computer system.

Regarding the system of any preceding paragraph, the instruction element storage comprises a compiled logical circuit region and a fixed subroutine region, wherein the dedicated memory regions further comprise a scratch memory region, an observable result region, a shared variable region, and a local variable region, and wherein the shared variable region is communicatively accessible by one or more additional logical control units comprised by the system.

The system of any preceding paragraph further comprises the code control unit that determines how to execute the logical instruction as a set of one or more physical instructions, comprising the physical instruction, and that generates the physical instruction based on the logical instruction and based on coordination with a physical clock timing driving execution of a physical quantum circuit at the quantum computer system, wherein the logical control unit is agnostic to the physical clock timing due to operating a lower-complexity interface requiring lower bandwidth for the operation of the instruction interface than is employed by the code control unit.

In the system of any preceding paragraph, a group of code control units, comprising the code control unit and one or more additional code control units, are assigned to the circuit execution unit, and wherein additional quantum hardware of the quantum computer system, different from the specified quantum hardware, are controllable by the one or more additional code control units.

The system of any preceding paragraph further comprises a hierarchical distributed logical control unit network comprising the logical control unit and one or more additional logical control units networked to one another, wherein each of the one or more additional logical control units comprises a respective one or more circuit execution units, other than the circuit execution unit, that each are assigned to a different respective one or more code control units, other than the code control unit, and wherein the logical control unit and the one or more additional logical control units comprise respective dedicated shared variable regions at respective memories thereof, comprising the memory, that are accessible to others of the logical control units of the hierarchical distributed logical control unit network.

A computer-implemented method, comprises operating, by a logical control unit operably couplable to a quantum computer system, an instruction interface with the quantum computer system for logical control over an operation of a quantum program at the quantum computer system, storing, by the logical control unit, an instruction element at an instruction element storage of dedicated memory regions of a memory of the logical control unit, the memory operably coupled to a programmable processor of the logical control unit, interpreting, by a circuit execution unit of the logical control unit, the quantum program, generating, by the circuit execution unit, using the instruction element, a logical instruction that comprises a discrete higher-level instruction for the operation of the quantum program at the quantum computer system, and interfacing, by the circuit execution unit, with a code control unit for provision of the logical instruction for use by the code control unit in generating a physical instruction that comprises a lower-level instruction for execution of a specified quantum hardware of the quantum computer system.

Regarding the computer-implemented method of the preceding paragraph, operations performed by the logical control unit and the circuit execution unit, comprising the interpreting and interfacing, are agnostic to event timing by which the code control unit operates.

Regarding the computer-implemented method of any preceding paragraph, the instruction interface operated by the logical control unit comprises a lower-complexity interface requiring lower bandwidth for operating per code control unit, comprising the code control unit, than is employed by the code control unit.

The computer-implemented method of any preceding paragraph further comprises generating, by the lower-complexity interface, comprising the circuit execution unit, logical instructions, comprising the logical instruction, at a first average instruction rate that is less than a second average instruction rate at which the code control unit generates physical instructions, comprising the physical instruction.

The computer-implemented method of any preceding paragraph further comprises obtaining, by the logical control unit, a classical observable result defining a quantum measurement readout of the quantum computer system, storing, by the logical control unit, the classical observable result at an observable result region of the dedicated memory regions, and executing, by the circuit execution unit, classical control flow driving adaptation of quantum operations for the quantum program by generating the logical instruction based on the classical observable result during the operation of the quantum program at the quantum computer system.

A computer program product facilitates adaptation of an operation of a quantum program at a quantum computer system. The computer program product comprises a computer readable storage medium having program instructions embodied therewith, the program instructions executable by a processor of a logical control unit operably couplable to the quantum computer system to cause the processor to operate, by the processor, an instruction interface with the quantum computer system for logical control over the operation of the quantum program at the quantum computer system, store, by the processor, an instruction element at an instruction element storage of dedicated memory regions of a memory of the logical control unit, the memory operably coupled to the processor, interpret, by the processor, the quantum program, generate, by the processor, using the instruction element, a logical instruction that comprises a discrete higher-level instruction for the operation of the quantum program at the quantum computer system, and interface, by the processor, with a code control unit for provision of the logical instruction for use by the code control unit in generating a physical instruction that comprises a lower-level instruction for execution of a specified quantum hardware of the quantum computer system.

Regarding the computer program product of the preceding paragraph, operations performed by the logical control unit, comprising the interpreting and interfacing, are agnostic to event timing by which the code control unit operates.

Regarding the computer program product of any preceding paragraph, the instruction interface operated by the logical control unit comprises a lower-complexity interface requiring lower bandwidth for operating per code control unit, comprising the code control unit, than is employed by the code control unit.

Regarding the computer program product of any preceding paragraph, the program instructions are further executable by the processor to cause the processor to generate, by the processor, logical instructions, comprising the logical instruction, at a first average instruction rate that is less than a second average instruction rate at which the code control unit generates physical instructions, comprising the physical instruction.

Regarding the computer program product of any preceding paragraph, the program instructions are further executable by the processor to cause the processor to obtain, by the processor, a classical observable result defining a quantum measurement readout of the quantum computer system, store, by the processor, the classical observable result at an observable result region of the dedicated memory regions, and execute, by the processor, classical control flow driving adaptation of quantum operations for the quantum program by generating the logical instruction based on the classical observable result during the operation of the quantum program at the quantum computer system.

### Computing Environment Description

Turning next to FIG. 13, a detailed description is provided of additional context for the one or more embodiments described herein at FIGS. 1-12.

FIG. 13 and the following discussion are intended to provide a brief, general description of a suitable computing environment 1300 in which one or more embodiments described herein at FIGS. 1-13 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as translation of an original source code based on an instruction generation code 1380. In addition to block 1380, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1380, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, one or more instructions for performing the inventive methods may be stored in block 1380 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid-state storage devices. Operating system 1322 may take several forms, such as various known proprietary operating systems or open-source Portable Operating System Interface type operating systems that employ a kernel. The code included in block 1380 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing large amounts of data, such as a storage area network (SAN) that is shared by multiple, geographically distributed computers. IoT sensor set 1325 is made up of sensors that can be used in Internet of Things applications. For example, one sensor may be a thermometer, and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301) and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine that collects and stores helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate via WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution, and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a logical control unit operably couplable to a quantum computer system and operating an instruction interface with the quantum computer system for logical control over an operation of a quantum program at the quantum computer system, the logical control unit comprising:
a programmable processor;
a memory, operably coupled to the programable processor and comprising dedicated memory regions comprising an instruction element storage; and
a circuit execution unit that interprets the quantum program and generates, using an instruction element of the instruction element storage, a logical instruction that comprises a discrete higher-level instruction for the operation of the quantum program at the quantum computer system,
wherein the circuit execution unit interfaces with a code control unit for provision of the logical instruction for use by the code control unit in generating a physical instruction that comprises a lower-level instruction for execution of a specified quantum hardware of the quantum computer system.

2. The system of claim 1, wherein the circuit execution unit executes classical control flow driving adaptation of quantum operations for the quantum program by generating the logical instruction during the operation of the quantum program at the quantum computer system.

3. The system of claim 1, wherein operations performed by the logical control unit and the circuit execution unit, comprising the interpreting and interfacing, are agnostic to event timing by which the code control unit operates.

4. The system of claim 1, wherein the instruction interface operated by the logical control unit comprises a lower-complexity interface requiring lower bandwidth for operating per code control unit, comprising the code control unit, than is employed by the code control unit.

5. The system of claim 4, wherein the lower-complexity interface, comprising the circuit execution unit, generates logical instructions, comprising the logical instruction, at a first average instruction rate that is less than a second average instruction rate at which the code control unit generates physical instructions, comprising the physical instruction.

6. The system of claim 1, wherein the logical control unit further comprises:
an acquiring engine that obtains a classical observable result defining a quantum measurement readout of the quantum computer system and that stores the classical observable result at an observable result region of the dedicated memory regions,
wherein the circuit execution unit executes classical control flow driving adaptation of quantum operations for the quantum program by generating the logical instruction based on the classical observable result during the operation of the quantum program at the quantum computer system.

7. The system of claim 1, wherein the instruction element storage comprises a compiled logical circuit region and a fixed subroutine region, wherein the dedicated memory regions further comprise a scratch memory region, an observable result region, a shared variable region, and a local variable region, and wherein the shared variable region is communicatively accessible by one or more additional logical control units comprised by the system.

8. The system of claim 1, further comprising:
the code control unit that determines how to execute the logical instruction as a set of one or more physical instructions, comprising the physical instruction, and that generates the physical instruction based on the logical instruction and based on coordination with a physical clock timing driving execution of a physical quantum circuit at the quantum computer system,
wherein the logical control unit is agnostic to the physical clock timing due to operating a lower-complexity interface requiring lower bandwidth for the operation of the instruction interface than is employed by the code control unit.

9. The system of claim 1, wherein a group of code control units, comprising the code control unit and one or more additional code control units, are assigned to the circuit execution unit, and wherein additional quantum hardware of the quantum computer system, different from the specified quantum hardware, are controllable by the one or more additional code control units.

10. The system of claim 1, further comprising:
a hierarchical distributed logical control unit network comprising the logical control unit and one or more additional logical control units networked to one another,
wherein each of the one or more additional logical control units comprises a respective one or more circuit execution units, other than the circuit execution unit, that each are assigned to a different respective one or more code control units, other than the code control unit, and
wherein the logical control unit and the one or more additional logical control units comprise respective dedicated shared variable regions at respective memories thereof, comprising the memory, that are accessible to others of the logical control units of the hierarchical distributed logical control unit network.

11. A computer-implemented method, comprising:
operating, by a logical control unit operably couplable to a quantum computer system, an instruction interface with the quantum computer system for logical control over an operation of a quantum program at the quantum computer system;
storing, by the logical control unit, an instruction element at an instruction element storage of dedicated memory regions of a memory of the logical control unit, the memory operably coupled to a programmable processor of the logical control unit;
interpreting, by a circuit execution unit of the logical control unit, the quantum program;
generating, by the circuit execution unit, using the instruction element, a logical instruction that comprises a discrete higher-level instruction for the operation of the quantum program at the quantum computer system; and
interfacing, by the circuit execution unit, with a code control unit for provision of the logical instruction for use by the code control unit in generating a physical instruction that comprises a lower-level instruction for execution of a specified quantum hardware of the quantum computer system.

12. The computer-implemented method of claim 11, wherein operations performed by the logical control unit and the circuit execution unit, comprising the interpreting and interfacing, are agnostic to event timing by which the code control unit operates.

13. The computer-implemented method of claim 11, wherein the instruction interface operated by the logical control unit comprises a lower-complexity interface requiring lower bandwidth for operating per code control unit, comprising the code control unit, than is employed by the code control unit.

14. The computer-implemented method of claim 13, further comprising:
generating, by the lower-complexity interface, comprising the circuit execution unit, logical instructions, comprising the logical instruction, at a first average instruction rate that is less than a second average instruction rate at which the code control unit generates physical instructions, comprising the physical instruction.

15. The computer-implemented method of claim 11, further comprising:
obtaining, by the logical control unit, a classical observable result defining a quantum measurement readout of the quantum computer system;
storing, by the logical control unit, the classical observable result at an observable result region of the dedicated memory regions; and
executing, by the circuit execution unit, classical control flow driving adaptation of quantum operations for the quantum program by generating the logical instruction based on the classical observable result during the operation of the quantum program at the quantum computer system.

16. A computer program product facilitating adaptation of an operation of a quantum program at a quantum computer system, the computer program product comprising a computer readable storage medium having program instructions embodied therewith, the program instructions executable by a processor of a logical control unit operably couplable to the quantum computer system to cause the processor to:
operate, by the processor, an instruction interface with the quantum computer system for logical control over the operation of the quantum program at the quantum computer system;
store, by the processor, an instruction element at an instruction element storage of dedicated memory regions of a memory of the logical control unit, the memory operably coupled to the processor;
interpret, by the processor, the quantum program;
generate, by the processor, using the instruction element, a logical instruction that comprises a discrete higher-level instruction for the operation of the quantum program at the quantum computer system; and
interface, by the processor, with a code control unit for provision of the logical instruction for use by the code control unit in generating a physical instruction that comprises a lower-level instruction for execution of a specified quantum hardware of the quantum computer system.

17. The computer program product of claim 16, wherein operations performed by the logical control unit, comprising the interpreting and interfacing, are agnostic to event timing by which the code control unit operates.

18. The computer program product of claim 16, wherein the instruction interface operated by the logical control unit comprises a lower-complexity interface requiring lower bandwidth for operating per code control unit, comprising the code control unit, than is employed by the code control unit.

19. The computer program product of claim 18, wherein the program instructions are further executable by the processor to cause the processor to:
generate, by the processor, logical instructions, comprising the logical instruction, at a first average instruction rate that is less than a second average instruction rate at which the code control unit generates physical instructions, comprising the physical instruction.

20. The computer program product of claim 16, wherein the program instructions are further executable by the processor to cause the processor to:
obtain, by the processor, a classical observable result defining a quantum measurement readout of the quantum computer system;
store, by the processor, the classical observable result at an observable result region of the dedicated memory regions; and
execute, by the processor, classical control flow driving adaptation of quantum operations for the quantum program by generating the logical instruction based on the classical observable result during the operation of the quantum program at the quantum computer system.
